(19) United States
(12) Patent Application Publication
(10) Pub. No.: US 2026/0059227 A1
(43) Pub. Date: Feb. 26, 2026

(54) ACOUSTIC OUTPUT DEVICES

(71) Applicant: SHENZHEN SHOKZ CO., LTD., Shenzhen (CN)

(72) Inventors: Jianing LIANG, Shenzhen (CN); Lei ZHANG, Shenzhen (CN); Xin QI, Shenzhen (CN)

(73) Assignee: SHENZHEN SHOKZ CO., LTD., Shenzhen (CN)

(21) Appl. No.: 19/378,431

(22) Filed: Nov. 4, 2025

Related U.S. Application Data
(63) Continuation of application No. PCT/CN2024/095477, filed on May 27, 2024.

(51) Int. Cl. H04R 1/24; H04R 1/10; H04R 7/12; H04R 9/02; H04R 9/06

(52) U.S. Cl. CPC H04R 1/24; H04R 1/1008; H04R 1/1075; H04R 7/127; H04R 9/025; H04R 9/06; H04R 1/105

(57) ABSTRACT

One or more embodiments of the present disclosure relate to an acoustic output device. The acoustic output device includes a housing, a support structure, a first loudspeaker, and a second loudspeaker. The housing forms an inner cavity; the support structure is configured to wear the housing on an ear without blocking an ear canal. The first loudspeaker is accommodated within the inner cavity, and the first loudspeaker includes a first magnet and a first diaphragm. The first magnet and the first diaphragm are spaced apart along a vibration direction of the first diaphragm. The second loudspeaker is accommodated within the inner cavity, and the second loudspeaker includes a second magnet and a second diaphragm. The second magnet and the second diaphragm are spaced apart along a vibration direction of the second diaphragm.

### CROSS-REFERENCE TO RELATED APPLICATIONS

This application is a Continuation of International Patent Application No. PCT/CN2024/095477, filed on May 27, 2024, the entire contents of which are incorporated herein by reference.

### TECHNICAL FIELD

The present disclosure relates to the field of acoustic technology, and in particular, to acoustic output devices.

### BACKGROUND

Open-ear earphones are a portable audio output device that achieves directional sound transmission. Compared with traditional in-ear and over-ear earphones, the open-ear earphones do not block or cover the ear canal, allowing users to acquire sound information from the surrounding environment while listening to music, thereby improving both safety and comfort. To ensure the audio performance of the open-ear earphones, the design of a loudspeaker is extremely important. Specifically, to enhance sound output, the loudspeaker of the open-ear earphones requires a special design to satisfy the sound pressure requirements of the open-ear earphones within specific frequency bands.

### SUMMARY

One or more embodiments of the present disclosure provide an acoustic output device. The acoustic output device includes a housing, a support structure, a first loudspeaker, and a second loudspeaker. The housing forms an inner cavity; the support structure is configured to position the housing on an ear without blocking an ear canal; the first loudspeaker is accommodated within the inner cavity, and the first loudspeaker includes a first magnet and a first diaphragm, the first magnet and the first diaphragm are spaced apart along a vibration direction of the first diaphragm; and the second loudspeaker is accommodated within the inner cavity, and the second loudspeaker includes a second magnet and a second diaphragm, and the second magnet and the second diaphragm are spaced apart along a vibration direction of the second diaphragm. Identical magnetic poles of the first magnet and the second magnet are disposed opposite to each other.

In some embodiments, a frequency of at least a portion of sound output by the first loudspeaker is lower than a frequency of sound output by the second loudspeaker.

In some embodiments, an axis of the first magnet is disposed parallel and spaced apart from an axis of the second magnet.

In some embodiments, a first sound outlet hole and a second sound outlet hole are disposed on an inner side surface of the housing. The first sound outlet hole is acoustically coupled to the first diaphragm, and the second sound outlet hole is acoustically coupled to the second diaphragm. The inner side surface is a side surface of the housing facing an opening of the ear canal in a wearing state.

In some embodiments, in the wearing state, an orthogonal projection of a centroid of the second sound outlet hole on a sagittal plane of a human body is closer to the opening of the ear canal than an orthogonal projection of a centroid of the first sound outlet hole on the sagittal plane of the human body.

In some embodiments, in the wearing state, an orthogonal projection of a center of the second magnet on a sagittal plane of a human body is closer to the opening of the ear canal than an orthogonal projection of a center of the first magnet on the sagittal plane of the human body.

In some embodiments, on a plane where a surface of the first magnet facing the first diaphragm is located, an orthogonal projection of the second magnet and an orthogonal projection of the first magnet are at least partially overlapped.

In some embodiments, in the wearing state, at least a portion of the housing extends into a concha cavity of the ear, and at least a portion of a side surface of the housing abuts against the concha cavity.

In some embodiments, the first diaphragm includes a main body region and a folded annular region surrounding the main body region, the main body region includes a dome-shaped portion, a projection of a center of the second magnet on the first diaphragm along an axis of the second magnet is located between a center of the dome-shaped portion and an inner edge of the folded annular region, and the inner edge of the folded annular region is connected to the dome-shaped portion.

In some embodiments, the inner cavity includes a first cavity and a second cavity separated from each other. The first loudspeaker is accommodated within the first cavity, and the second loudspeaker is accommodated within the second cavity.

In some embodiments, a first distance between a magnetic circuit where the first magnet is located and a magnetic circuit where the second magnet is located along the vibration direction of the first diaphragm is in a range of 2.85 mm to 3.42 mm.

In some embodiments, the first distance between the magnetic circuit where the first magnet is located and the magnetic circuit where the second magnet is located along the vibration direction of the first diaphragm is in a range of 3 mm to 3.2 mm.

In some embodiments, on a plane where a surface of the first magnet facing the first diaphragm is located, a distance between an orthogonal projection of a centroid of the first diaphragm and an orthogonal projection of a centroid of the second diaphragm is in a range of 0 mm to 8 mm.

In some embodiments, the second loudspeaker further includes a third magnet, and the third magnet is arranged surrounding the second magnet.

In some embodiments, the second loudspeaker further includes a fourth magnet. The fourth magnet and the second magnet are arranged along the vibration direction of the second diaphragm, and identical magnetic poles of the fourth magnet and the second magnet are disposed opposite to each other.

In some embodiments, a ratio of an area of a cross-section of the second magnet perpendicular to an axis of the second magnet to an area of a cross-section of the third magnet perpendicular to an axis of the third magnet is in a range of 0.1 to 4.

In some embodiments, the ratio of the area of the cross-section of the second magnet along the direction perpendicular to the axis of the second magnet to the area of the cross-section of the third magnet along the direction perpendicular to the axis of the third magnet is in a range of 0.4 to 0.6.

In some embodiments, the first loudspeaker includes a first coil. The first coil is connected to the first diaphragm and at least partially located in a magnetic field formed by the first magnet, and the first coil drives the first diaphragm to vibrate to produce sound after being energized. A magnetic flux intensity at any position on the first coil is greater than 0.45 T.

In some embodiments, the second loudspeaker includes a second coil. The second coil is connected to the second diaphragm and at least partially located in a magnetic field formed by the second magnet, and the second coil drives the second diaphragm to vibrate to produce sound after being energized. A magnetic flux intensity at any position on the second coil is greater than 0.3 T.

One or more embodiments of the present disclosure further provide an acoustic output device. The acoustic output device includes a housing, a support structure, a first loudspeaker, and a second loudspeaker. The housing forms an inner cavity; the support structure is configured to position the housing on an ear without blocking an ear canal; the first loudspeaker is accommodated within the inner cavity, and the first loudspeaker includes a first magnet and a first diaphragm, the first magnet and the first diaphragm are spaced apart along a vibration direction of the first diaphragm; and the second loudspeaker is accommodated within the inner cavity, and the second loudspeaker includes a second magnet and a second diaphragm, the second magnet and the second diaphragm are spaced apart along a vibration direction of the second diaphragm. An axis of the second magnet is inclined relative to an axis of the first magnet.

In some embodiments, on a plane where a surface of the first magnet facing the first diaphragm is located, there is a spacing between an orthogonal projection of the second diaphragm and an orthogonal projection of the first diaphragm.

In some embodiments, a frequency of at least a portion of sound output by the first loudspeaker is lower than a frequency of sound output by the second loudspeaker.

In some embodiments, a first sound outlet hole and a second sound outlet hole are disposed on a lower side surface of the housing. The first sound outlet hole is acoustically coupled to the first diaphragm, and the second sound outlet hole is acoustically coupled to the second diaphragm. The lower side surface is a side surface of the housing facing away from a top of the head of a user in a wearing state.

In some embodiments, a first sound outlet hole is disposed on an inner side surface of the housing, and a second sound outlet hole is disposed on a lower side surface of the housing. The first sound outlet hole is acoustically coupled to the first diaphragm, and the second sound outlet hole is acoustically coupled to the second diaphragm. The inner side surface is a side surface of the housing facing an antihelix in a wearing state, and the lower side surface is a side surface of the housing facing away from a top of the head of a user in the wearing state.

In some embodiments, the axis of the first magnet is perpendicular to the axis of the second magnet. The first magnet and the second magnet are spaced apart along the vibration direction of the second diaphragm.

In some embodiments, an angle formed between the axis of the first magnet and the axis of the second magnet is in a range of 10°to 45°.

In some embodiments, a third distance between a magnetic circuit where the first magnet is located and a magnetic circuit where the second magnet is located is in a range of 1.5 mm to 2.5 mm.

In some embodiments, in a wearing state, the support structure positions the housing at an antihelix of the ear, and a portion of a side surface of the housing abuts against the antihelix.

In some embodiments, the inner cavity includes a first cavity and a second cavity separated from each other. The first loudspeaker is accommodated within the first cavity, and the second loudspeaker is accommodated within the second cavity.

In some embodiments, the second loudspeaker further includes a third magnet, and the third magnet is arranged surrounding the second magnet.

In some embodiments, the second loudspeaker further includes a fourth magnet. The second magnet and the fourth magnet are arranged along the vibration direction of the second diaphragm. Identical magnetic poles of the second magnet and the fourth magnet are disposed opposite to each other.

In some embodiments, a ratio of an area of a cross-section of the second magnet perpendicular to an axis of the second magnet to an area of a cross-section of the third magnet perpendicular to an axis of the third magnet is in a range of 0.1 to 4.

In some embodiments, the ratio of the area of the cross-section of the second magnet along the direction perpendicular to the axis of the second magnet to the area of the cross-section of the third magnet along the direction perpendicular to the axis of the third magnet is in a range of 0.4 to 0.6.

In some embodiments, the first loudspeaker includes a first coil. The first coil is connected to the first diaphragm and at least partially located in a magnetic field formed by the first magnet, and the first coil drives the first diaphragm to vibrate to produce sound after being energized. A magnetic flux intensity at any position on the first coil is in a range of 0.44 T to 0.67 T.

In some embodiments, the second loudspeaker includes a second coil. The second coil is connected to the second diaphragm and at least partially located in a magnetic field formed by the second magnet, and the second coil drives the second diaphragm to vibrate to produce sound after being energized. A magnetic flux intensity at any position on the second coil is in a range of 0.3 T to 0.6 T.

### BRIEF DESCRIPTION OF THE DRAWINGS

The present disclosure is further illustrated by way of exemplary embodiments. These exemplary embodiments are described in detail with reference to the accompanying drawings. These embodiments are non-limiting, and in these embodiments, the same numerals refer to the same structures, where:

FIG. 1 is a schematic diagram illustrating an exemplary ear according to some embodiments of the present disclosure;

FIG. 2 is a schematic diagram illustrating an exemplary wearing scenario of an open-ear earphone according to some embodiments of the present disclosure;

FIG. 3A is a schematic diagram illustrating an exemplary framework of an acoustic output device according to some embodiments of the present disclosure;

FIG. 3B is a schematic diagram illustrating an exemplary structure of an acoustic output device according to some embodiments of the present disclosure;

FIG. 3C is a schematic diagram illustrating an exemplary structure of an acoustic output device according to other embodiments of the present disclosure;

FIG. 4 is a schematic diagram illustrating an exemplary internal structure of a first loudspeaker according to some embodiments of the present disclosure;

FIG. 5A is a schematic diagram illustrating a positional relationship between a first loudspeaker and a second loudspeaker and a distribution of magnetic fields of the first loudspeaker and the second loudspeaker according to some embodiments of the present disclosure;

FIG. 5B is a schematic diagram illustrating a distribution of a magnetic field of a first loudspeaker according to some embodiments of the present disclosure;

FIG. 6A is a schematic diagram illustrating an exemplary wearing scenario of an acoustic output device according to some embodiments of the present disclosure;

FIG. 6B is a schematic diagram illustrating an exemplary distribution of a cavity structure arranged around one of dual sound sources according to some embodiments of the present disclosure;

FIG. 7A is a schematic diagram illustrating different relative positions between a first loudspeaker and a second loudspeaker along a horizontal direction according to some embodiments of the present disclosure;

FIG. 7B is a schematic diagram illustrating a distribution of magnetic fields of a first loudspeaker and a second loudspeaker according to some embodiments of the present disclosure;

FIG. 7C is a trend graph illustrating a change in a magnetic flux intensity at an end point of a first coil of a first loudspeaker when the first loudspeaker and a second loudspeaker are located in different relative positions along a horizontal direction according to some embodiments of the present disclosure;

FIG. 7D is a trend graph illustrating a change in an average magnetic flux intensity at a first coil according to some embodiments of the present disclosure;

FIG. 8 is a schematic diagram illustrating an exemplary structure of a second loudspeaker according to some embodiments of the present disclosure;

FIG. 9 is a schematic diagram illustrating another exemplary structure of a second loudspeaker according to some embodiments of the present disclosure;

FIG. 10 is a graph illustrating curves of sound pressure levels of a second loudspeaker with a dual-magnet configuration and with a triple-magnet configuration according to some embodiments of the present disclosure;

FIG. 11A is a schematic diagram illustrating an exemplary structure of a second magnet and a third magnet according to some embodiments of the present disclosure;

FIG. 11B is a schematic diagram illustrating an exemplary structure of a second magnet and a third magnet according to some other embodiments of the present disclosure;

FIG. 11C is a graph illustrating effect of an area ratio of a second magnet to a third magnet on a magnetic flux intensity at a first coil according to some embodiments of the present disclosure;

FIG. 12 is a schematic diagram illustrating another exemplary structure of an acoustic output device according to some embodiments of the present disclosure;

FIG. 13A is a schematic diagram illustrating another wearing manner of an acoustic output device according to some embodiments of the present disclosure;

FIG. 13B is a schematic diagram illustrating an exemplary structure of a baffle disposed between dual sound sources according to some embodiments of the present disclosure;

FIG. 14 is a schematic diagram illustrating a distribution of magnetic fields of a first loudspeaker and a second loudspeaker arranged in a first magnet arrangement manner according to some embodiments of the present disclosure; and

FIG. 15 is a schematic diagram illustrating a distribution of magnetic fields of a first loudspeaker and a second loudspeaker arranged in a third magnet arrangement manner according to some embodiments of the present disclosure.

### DETAILED DESCRIPTION

To more clearly illustrate the technical solutions of the embodiments in the present disclosure, the accompanying drawings used in the description of the embodiments are briefly introduced below. Obviously, the accompanying drawings in the following description are merely some examples or embodiments of the present disclosure. For a person of ordinary skill in the art, the present disclosure can be applied to other similar scenarios based on these accompanying drawings without creative effort. Unless obviously obtained from the context or the context illustrates otherwise, the same numeral in the drawings refers to the same structure or operation.

It should be understood that the terms “system”, “device”, “unit”, and/or “module” used herein are methods for distinguishing different components, elements, parts, sections, or assemblies at different levels. However, if other words can achieve the same purpose, the words may be replaced by other expressions.

As shown in the present disclosure and the claims, unless the context clearly indicates an exception, words such as “a”, “an”, “one”, and/or “the” are not specific to the singular and may also include the plural. Generally, the terms “include” and “comprise” only suggest the inclusion of explicitly identified steps and elements. These steps and elements do not constitute an exclusive list, and a method or device may also include other steps or elements.

In the description of the present disclosure, it should be understood that the terms “first”, “second”, “third”, and “fourth”, are used for descriptive purposes only and cannot be understood as indicating or implying relative importance or implicitly indicating the quantity of the indicated technical features. Thus, features defined with “first”, “second”, “third”, or “fourth” may explicitly or implicitly include at least one such feature. In the description of the present disclosure, the meaning of “a plurality of” is at least two, e.g., two, three, etc., unless explicitly and specifically defined otherwise.

In the present disclosure, unless explicitly specified and defined otherwise, terms such as “connect” and “fix” should be understood broadly. For example, the term “connect” refers to a fixed connection, a detachable connection, or an integrated connection. It may be a mechanical connection or an electrical connection. It may be a direct connection or an indirect connection through an intermediate medium. It may be an internal communication between two elements or an interaction relationship between two elements, unless explicitly defined otherwise. A person of ordinary skill in the art can understand the specific meanings of the above terms in the present disclosure based on specific situations.

The present disclosure uses flowcharts to illustrate operations performed by systems according to embodiments of the present disclosure. It should be understood that preceding or following operations are not necessarily performed precisely in sequence. Conversely, various operations may be processed in reverse order or simultaneously. Meanwhile, other operations may be added to these processes, or one or more operations may be removed from these processes.

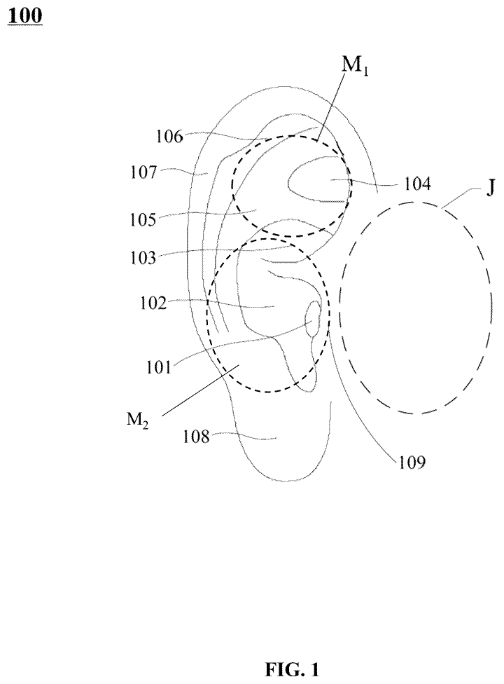

FIG. 1 is a schematic diagram illustrating an exemplary ear according to some embodiments of the present disclosure. Referring to FIG. 1, an ear 100 may include an ear canal 101, a concha cavity 102, a cymba conchae 103, a triangular fossa 104, an antihelix 105, a scaphoid fossa 106, a helix 107, an earlobe 108, and a crus of helix 109. In some embodiments, an acoustic output device may be worn and stabilized by utilizing one or more portions of the ear 100. In some embodiments, portions such as the ear canal 101, the concha cavity 102, the cymba conchae 103, and the triangular fossa 104 have a certain depth and volume in a three-dimensional space, which may be used to satisfy the wearing requirements of the acoustic output device. For example, the acoustic output device (e.g., in-ear earphones) may be worn in the ear canal 101. In some embodiments, the acoustic output device may be worn by utilizing other portions of the ear 100 other than the ear canal 101. For example, the acoustic output device may be worn by utilizing the cymba conchae 103, the triangular fossa 104, the antihelix 105, the scaphoid fossa 106, the helix 107, or a combination thereof. In some embodiments, the earlobe 108 or other portions of the ear may be further utilized to improve the comfort and reliability of wearing the acoustic output device. By utilizing portions of the ear 100 other than the ear canal 101 to wear the acoustic output device and realize sound propagation, the ear canal 101 of a user can be “liberated”, thereby reducing the impact of the acoustic output device on the health of the user's ear. When the user wears the acoustic output device on the road, the acoustic output device does not block the ear canal 101 of the user, enabling the user to receive sounds from both the acoustic output device and the environment (e.g., horn sounds, bicycle bells, surrounding voices, traffic command signals, etc.), thereby reducing the probability of traffic accidents. For example, when the user wears the acoustic output device, the entire or a portion of the acoustic output device is located on a front side of the crus of helix 109 (e.g., a region J enclosed by the dashed line in FIG. 1). As another example, when the user wears the acoustic output device, the entire or a portion of the acoustic output device contacts an upper portion of the ear canal 101 (e.g., one or more positions such as where the crus of helix 109, the cymba conchae 103, the triangular fossa 104, the antihelix 105, the scaphoid fossa 106, and the helix 107 are located). As another example, when the user wears the acoustic output device, the entire or a portion of the acoustic output device is located at one or more portions of the ear (e.g., where the concha cavity 102, the cymba conchae 103, and the triangular fossa 104 are located). For example, the entire of a portion of the acoustic output device is located at regions M₁ and M₂ enclosed by the dashed line in FIG. 1.

Different users may have individual differences, resulting in variations in the ear, such as different shapes and dimensions. For ease of description and understanding, unless otherwise specified, the present disclosure will primarily use an ear model with a “standard” shape and dimension as a reference to further describe a wearing manner of the acoustic output device in different embodiments on the ear model. For example, a simulator containing a head and its (left and right) ears, fabricated based on ANSI: S3.36, S3.25 and IEC: 60318-7 standards, such as GRAS KEMAR, HEAD Acoustics, B&K 4128 series, or B&K 5128 series, may be used as a reference for wearing the acoustic output device to present scenarios in which most users normally wear the acoustic output device. Merely by way of example, using GRAS KEMAR as an example, an ear simulator may be any one of GRAS 45AC, GRAS 45BC, GRAS 45CC, or GRAS 43AG. Merely by way of example, using HEAD Acoustics as an example, the ear simulator may be any one of HMS II.3, HMS II.3 LN, or HMS II.3LN HEC. It should be noted that the data range measured in the embodiments of the present disclosure is based on the GRAS 45BC KEMAR. However, it should be understood that differences may exist between different head models and ear models, and the relevant data range may fluctuate by ±10% when using other models. Merely by way of example, a reference ear may have the following relevant features: a dimension of a projection of an auricle on a sagittal plane along a vertical axis is in a range of 49.5 mm to 74.3 mm, and a dimension of a projection of the auricle on the sagittal plane along a sagittal axis is in a range of 36.6 mm to 55 mm. The projection of the auricle on the sagittal plane refers to a projection of an edge of the auricle on the sagittal plane. The edge of the auricle is at least formed by the outer contour of the helix, the contour of the earlobe, the contour of the tragus, the intertragic notch, the antitragus, the crus helicis notch, etc. Therefore, in the present disclosure, descriptions such as “a user wears”, “in a worn state”, and “in a wearing state” refer to the acoustic output device described in the present disclosure being worn on an ear of the simulator. It should be understood that, considering individual differences among different users, the structure, shape, dimension, thickness, etc., of one or more portions in the ear 100 may be differentially designed according to ears of different shapes and dimensions. These differential designs may be reflected that feature parameters of the one or more portions in the acoustic output device (e.g., a sound production portion, ear hook, etc., described below) may have numerical values in different ranges to adapt to different ears.

It should be noted that in fields such as medicine and anatomy, three basic planes, including the sagittal plane, the coronal plane, and the horizontal plane, and three basic axes, including the sagittal axis, the coronal axis, and the vertical axis, can be defined for the human body. The sagittal plane refers to a plane cut along a front-rear direction of the body and perpendicular to the ground, which divides the human body into left and right portions. The coronal plane refers to a plane cut along a left-right direction of the body and perpendicular to the ground, which divides the human body into front and rear portions. The horizontal plane refers to a plane cut along an up-down direction perpendicular to the body and parallel to the ground, which divides the human body into upper and lower portions. Correspondingly, the sagittal axis refers to an axis along the front-rear direction of the body and perpendicular to the coronal plane. The coronal axis refers to an axis along the left-right direction of the body and perpendicular to the sagittal plane. The vertical axis refers to an axis along the up-down direction of the body and perpendicular to the horizontal plane.

The description of the ear 100 is for illustrative purposes only and is not intended to limit the scope of the present disclosure. For a person of ordinary skill in the art, various changes and modifications may be made based on the description of the present disclosure. For example, a portion of the acoustic output device blocks a portion or the entire of the ear canal 101. These changes and modifications still fall within the protection scope of the present disclosure.

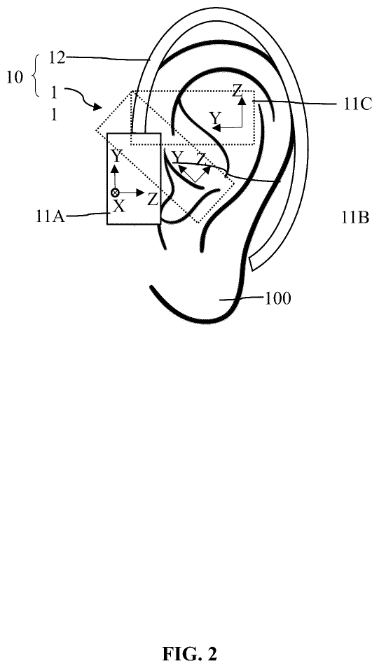

FIG. 2 is a schematic diagram illustrating an exemplary wearing scenario of an open-ear earphone according to some embodiments of the present disclosure. In some embodiments, an acoustic output device 10 includes, but is not limited to, an air-conduction earphone, a bone-conduction earphone, or the like. In some embodiments, the acoustic output device 10 may be integrated with products such as glasses, head-mounted earphones, a head-mounted display device, an AR/VR helmet, etc. As shown in FIG. 2, the acoustic output device 10 may include a housing 11 and a support structure 12. The housing 11 forms an inner cavity. One or more loudspeakers are located in an inner cavity formed by the housing 11. The support structure 12 is configured to position the housing 11 on an ear while not blocking an ear canal. In some embodiments, the support structure 12 is an ear hook 12. In some embodiments, the acoustic output device 10 may be worn on a body (e.g., the head, the neck, or upper torso) of the user through the ear hook 12 that supports the housing 11.

In some embodiments, when the acoustic output device 10 is in a wearing state, a first portion of the ear hook 12 is hooked between the auricle and head of the user, and a second portion of the ear hook 12 extends toward a side of the auricle that faces away from the head and is connected to a sound production portion. The ear hook 12 is configured to fix the housing 11 near the ear canal while not blocking the ear canal. In some embodiments, the ear hook 12 is an arc structure adapted to the auricle, so that the ear hook 12 may be suspended on the upper portion of the auricle of the user. In some embodiments, the ear hook 12 is a clamping structure adapted to the auricle, so that the ear hook 12 may be clamped on the auricle of the user. In some embodiments, the ear hook 12 includes, but is not limited to, a hook structure, an elastic band, etc., so that the acoustic output device 10 may be better fixed on the user's body to prevent the acoustic output device 10 from falling off during use.

In some embodiments, the housing 11 may be worn on the body of the user. A loudspeaker (e.g., a first loudspeaker and/or a second loudspeaker) is disposed in the housing 11 to produce a sound input to the ear 100 of the user. In some embodiments, the acoustic output device 10 may be integrated with products such as glasses, head-mounted earphones, a head-mounted display device, an AR/VR helmet, etc. In this case, the housing 11 may be worn near the ear 100 of the user by suspension or clamping. In some embodiments, the housing 11 is annular, elliptical, polygonal (regular or irregular), U-shaped, V-shaped, or semicircular, so that the housing 11 may be directly hooked on the ear 100 of the user.

With reference to FIG. 1 and FIG. 2, in some embodiments, when the user wears the acoustic output device 10, at least a portion of the housing 11 is located in the region J on the front side of a tragus of the ear 100 or in regions M₁ and M₂ within the auricle of the user, as shown in FIG. 1. Exemplary descriptions will be provided below in conjunction with different wearing positions of the housing 11 (positions 11A, 11B, and 11C shown in FIG. 2). It should be noted that in embodiments of the present disclosure, a front-outer side of the auricle refers to a side of the auricle that faces away from the head along the coronal axis. Correspondingly, a rear-inner side of the auricle refers to a side of the auricle that faces the head along the coronal axis. In some embodiments, the housing 11 located at the position 11A refers to the fact that the housing 11 is located on a side of the user's ear 100 that faces a facial region along the sagittal axis, i.e., the housing 11 is located in the region J at the front side of the ear 100.

In some embodiments, one or more loudspeakers are disposed in the housing 11. Classified by frequency, types of loudspeakers may include low-frequency (e.g., 30 Hz-150 Hz) loudspeakers, low-mid-frequency (e.g., 150 Hz-500 Hz) loudspeakers, mid-high-frequency (e.g., 500 Hz-5 kHz) loudspeakers, high-frequency (e.g., 5 kHz-16 kHz) loudspeakers, full-range (e.g., 30 Hz-16 kHz) loudspeakers, or any combination thereof. The terms “low”, “high”, and other frequency ranges mentioned here only indicate an approximate frequency range. In different application scenarios, the division may be different. For example, a crossover frequency is determined. “Low frequency” represents a frequency range below the crossover frequency, and “high frequency” represents a frequency range above the crossover frequency. The crossover frequency may be any value within an audible range of the human ear, e.g., 500 Hz, 800 Hz, 1000 Hz, 2000 Hz, 4000 Hz, or 8000 Hz.

In some embodiments, the loudspeaker includes a diaphragm. When the diaphragm vibrates, sounds may be emitted from a front side and a rear side of the diaphragm, respectively. A cavity formed by the housing of the acoustic output device 10 is at least divided by the diaphragm into a front cavity located on the front side of the diaphragm and a rear cavity located on the rear side of the diaphragm. The front cavity is acoustically coupled to a sound outlet hole on a side surface of the housing. Vibration of the diaphragm drives air in the front cavity to vibrate to produce an air-conduction sound, and the air-conduction sound produced by the front cavity is transmitted to the outside through the sound outlet hole.

In some embodiments, the housing 11 defines a long-axis direction Y and a short-axis direction Z that are perpendicular to a thickness direction X and orthogonal to each other. The long-axis direction Y may be defined as a direction corresponding to the maximum extension dimension in a shape of a two-dimensional projection of the housing 11 (e.g., a projection of the housing 11 on a plane where an outer side surface of the housing 11 is located, or a projection of the housing 11 on a sagittal plane). For example, when the shape of the projection is rectangular or approximately rectangular, the long-axis direction corresponds to the length direction of the rectangle or approximate rectangle. The short-axis direction Z may be defined as a direction perpendicular to the long-axis direction Y in the projection of the housing 11 on the sagittal plane. For example, when the shape of the projection is rectangular or approximately rectangular, the short-axis direction corresponds to the width direction of the rectangle or approximate rectangle. The thickness direction X may be defined as a direction perpendicular to the two-dimensional projection. For example, the thickness direction is aligned with the coronal axis and points toward the left-right direction of the human body. In some embodiments, when the housing 11 is in an inclined state in the wearing state, the long-axis direction Y and the short-axis direction Z remain parallel or approximately parallel to the sagittal plane. The long-axis direction Y may form an angle with the sagittal axis, i.e., the long-axis direction Y is correspondingly disposed in an inclined manner. The short-axis direction Z may form an angle with the vertical axis, i.e., the short-axis direction Z is correspondingly disposed in an inclined manner.

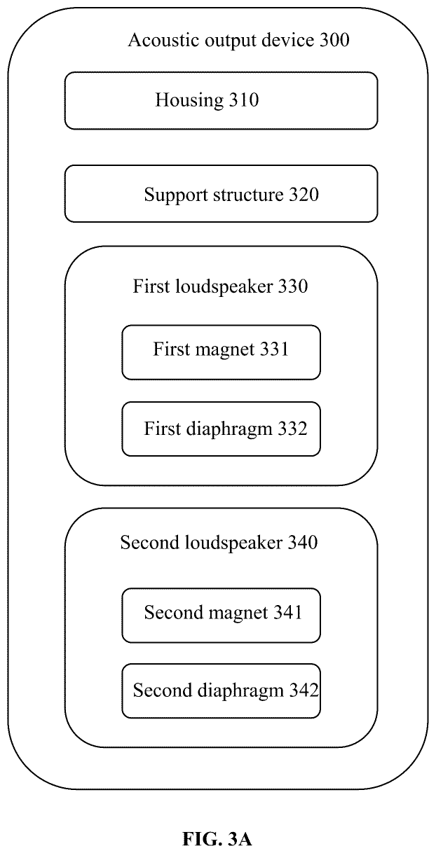

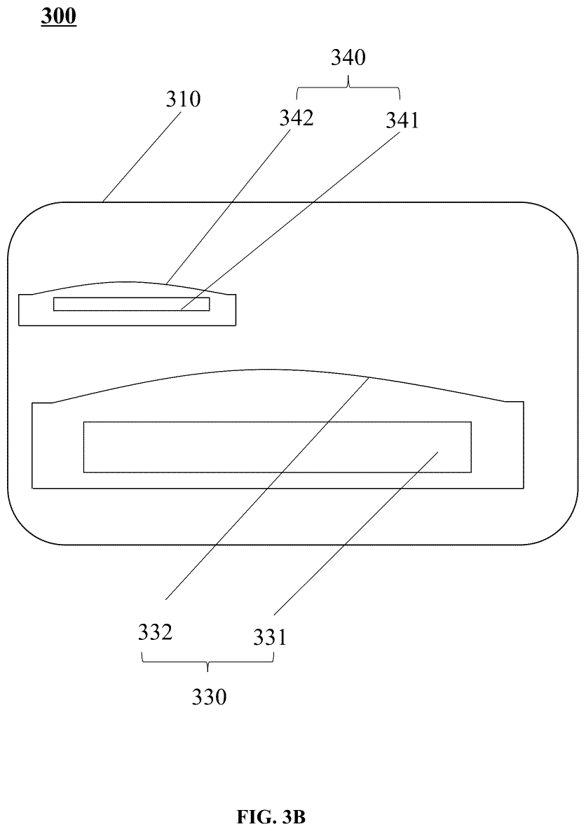

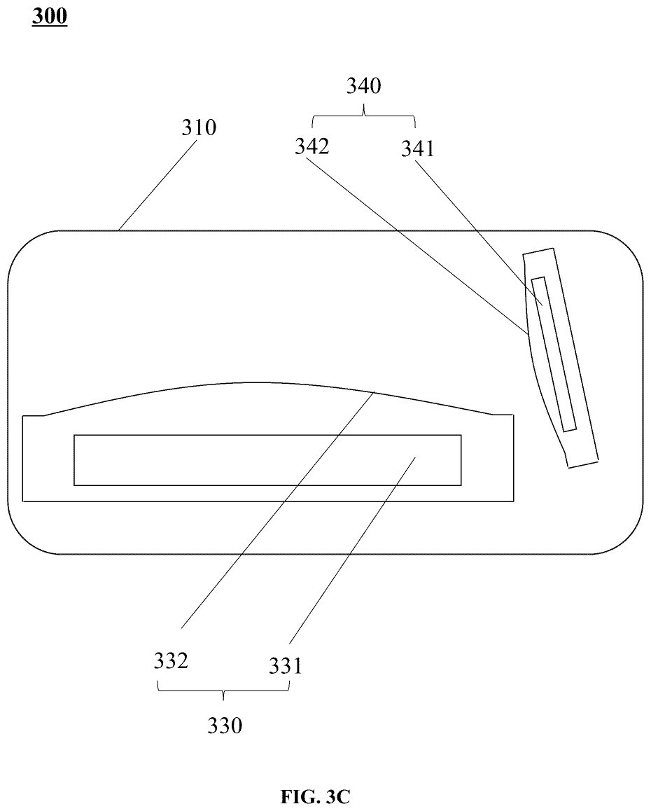

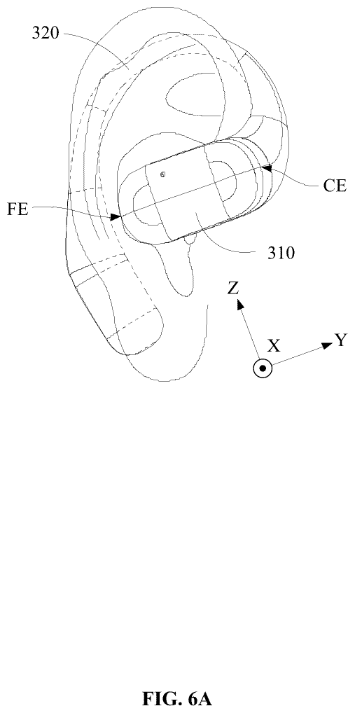

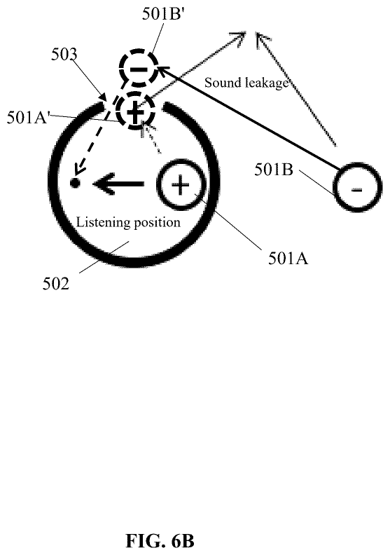

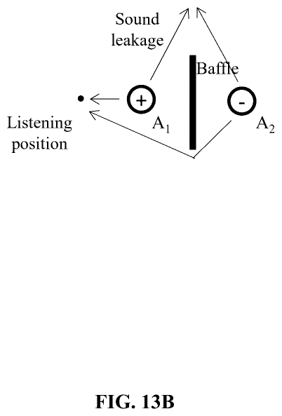

In some embodiments, the entire or a portion of the housing 11 extends into the concha cavity, i.e., a projection of the housing 11 on the sagittal plane and a projection of the concha cavity on the sagittal plane are at least partially overlapped. Specific descriptions regarding the housing 11 being worn at the position 11B may be referred to elsewhere in the present disclosure, e.g., FIG. 6A and the related descriptions thereof. In some embodiments, in the wearing state, the housing 11 is also in a horizontal state or an approximately horizontal state, as shown by the housing 11 located at the position 11C in FIG. 2. The long-axis direction Y is aligned or approximately aligned with the sagittal axis and points toward the front-rear direction of the human body. The short-axis direction Z is aligned or approximately aligned with the vertical axis and points toward the up-down direction of the body. Specific descriptions regarding the housing 11 being worn at the position 11C may be referred to elsewhere in the present disclosure, e.g., FIG. 13A and the related descriptions thereof. When the wearing manner of the acoustic output device 10 differs (i.e., the position of the housing 11 relative to the ear varies), an arrangement manner of loudspeakers in the acoustic output device 10 is adjusted accordingly to improve the sound output effect. For details, reference may be made to FIG. 3A to FIG. 15 and the related descriptions thereof. It should be noted that the housing 11 in the wearing state being in the approximately horizontal state, as shown in FIG. 2, refers to that an angle between the long-axis direction Y of the housing 11 and the sagittal axis is within a specific range (e.g., not greater than 20°). In addition, the wearing position of the housing 11 is not limited to the positions 11A, 11B, and 11C shown in FIG. 2, so long as it falls within the region J, region M₁, or region M₂ shown in FIG. 1. For example, the entire or a portion of the housing 11 is located in the region J enclosed by the dashed line in FIG. 1. As another example, the entire or a portion of the housing 11 contacts positions where one or more portions of the ear canal 101 are located, such as the crus of helix 109, the cymba conchae 103, the triangular fossa 104, the antihelix 105, the scaphoid fossa 106, and the helix 107. As a further example, the entire or a portion of the housing 11 is located in a cavity formed by one or more portions of the ear 100 (e.g., the concha cavity 102, the cymba conchae 103, and the triangular fossa 104.) For example, the region M₁ enclosed by the dashed line in FIG. 1 at least includes the cymba conchae 103 and the triangular fossa 104, and the region M₂ in FIG. 1 at least includes the concha cavity 102.

In some embodiments, to improve the stability of the acoustic output device 10 in the wearing state, the acoustic output device 10 may adopt any one or a combination of the following manners. For example, at least a portion of the ear hook 12 is configured as a contoured structure that conforms to at least one of a rear side of the ear or the head, so as to increase a contact area between the ear hook 12 and the ear and/or the head, thereby increasing a resistance of the acoustic output device 10 against falling off from the ear. For example, at least a portion of the ear hook 12 is configured as an elastic structure, so that it exhibits a certain amount of deformation in the wearing state, thereby increasing the positive pressure of the ear hook 12 on the ear and/or the head, in turn, increasing the resistance of the acoustic output device 10 against falling off from the ear. For example, at least a portion of the ear hook 12 is configured to abut against the head in the wearing state, thereby generating a reaction force pressing the ear, so that the housing 11 is pressed against the front side of the ear, thus increasing the resistance of the acoustic output device 10 against falling off from the ear. For example, the housing 11 and the ear hook 12 are configured to clamp regions where the antihelix, the concha cavity, and other anatomical portions are located from the front and rear sides of the ear in the wearing state, thereby increasing the resistance of the acoustic output device 10 against falling off from the ear. As another example, the housing 11 or an auxiliary structure connected to the housing 11 extends at least partially into anatomical portions such as the concha cavity, the cymba conchae, the triangular fossa, and the scaphoid fossa, thereby increasing the resistance of the acoustic output device 10 against falling off from the ear.

FIG. 3A is a schematic diagram illustrating an exemplary framework of an acoustic output device according to some embodiments of the present disclosure. FIG. 3B is a schematic diagram illustrating an exemplary structure of an acoustic output device according to some embodiments of the present disclosure. FIG. 3C is a schematic diagram illustrating an exemplary structure of an acoustic output device according to some other embodiments of the present disclosure. With reference to FIG. 3A to FIG. 3C, an acoustic output device 300 includes a housing 310, a support structure 320, a first loudspeaker 330, and a second loudspeaker 340. In some embodiments, the housing 310 is a frame body having a hollow structure. The housing 310 forms an inner cavity for accommodating other assemblies of the acoustic output device 300 (e.g., the first loudspeaker 330 and the second loudspeaker 340). In some embodiments, the housing 310 further serves to protect assemblies accommodated within the inner cavity. Merely by way of example, FIG. 3B and FIG. 3C show two different positional relationships between the first loudspeaker 330 and the second loudspeaker 340, respectively.

The support structure 320 is configured to support the acoustic output device 300. When the acoustic output device 300 is in a wearing state, the support structure 320 is located on an ear and supports the housing 310, so that the housing 310 is positioned on the ear while not blocking an ear canal. The term “not blocking an ear canal” refers to that at least a portion of the ear canal may communicate with the external environment. In some embodiments, the support structure 320 includes an ear hook. For more description regarding the ear hook, reference may be made to the relevant description of the ear hook 12 in FIG. 2 of the present disclosure, which will not be repeated here.

The first loudspeaker 330 is accommodated within the inner cavity formed by the housing 310. The first loudspeaker 330 may convert an electrical signal into a sound signal and output the sound signal. In some embodiments, the first loudspeaker 330 includes a first magnet 331 and a first diaphragm 332. The first magnet 331 and the first diaphragm 332 are spaced apart along a vibration direction of the first diaphragm 332. The first diaphragm 332 divides the inner cavity formed by the housing 310 into a first front cavity and a first rear cavity. The first front cavity of the first loudspeaker 330 may be a cavity formed on a side of the first diaphragm 332 facing away from the first magnet 331 (also referred to as a front side of the first diaphragm 332). The first rear cavity of the first loudspeaker 330 may be a cavity formed on a side of the first diaphragm 332 facing the first magnet 331 (also referred to as a rear side of the first diaphragm 332) or on a side of the first magnet 331 facing away from the first diaphragm 332. The first magnet 331 is configured to generate a magnetic field. The first diaphragm 332 may be connected to a coil. After the coil is energized, the coil vibrates under the action of a magnetic field and drives the first diaphragm 332 to vibrate. When the first diaphragm 332 vibrates, sounds are generated on a front side and a rear side of the first diaphragm 332, respectively. The sound generated on the front side of the first diaphragm 332 is radiated outward through the first front cavity, and the sound generated on the rear side of the first diaphragm 332 is radiated outward through the first rear cavity.

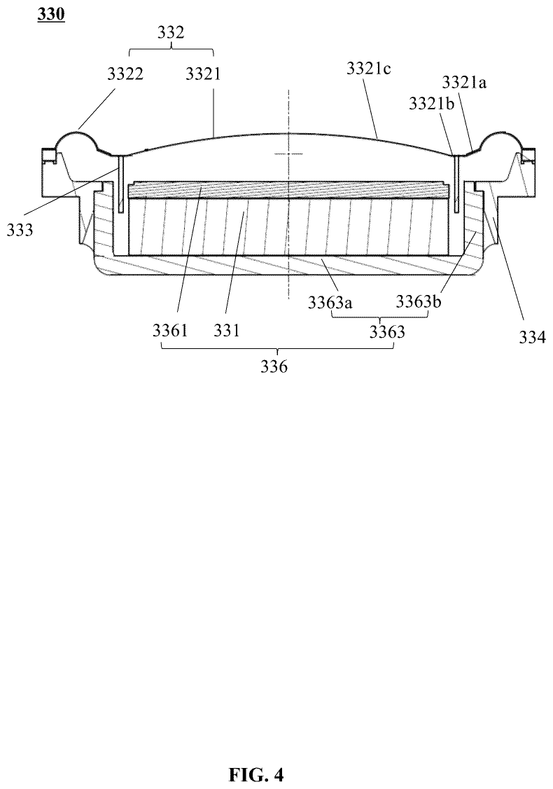

FIG. 4 is a schematic diagram illustrating an exemplary internal structure of a first loudspeaker according to some embodiments of the present disclosure. A bracket 334 surrounds the first diaphragm 322, a first coil 333, and a magnetic circuit assembly 336, and provides a platform for installation and fixation. The first loudspeaker 330 may be connected to the housing 310 of the acoustic output device 300 through the bracket 334. The first coil 333 extends into the magnetic circuit assembly 336 and is connected to the first diaphragm 322. The magnetic circuit assembly 336 exerts a force on the energized first coil 333, thereby driving the first diaphragm 322 to generate mechanical vibration. A sound is then generated through propagation of a medium, such as air, and output through a sound outlet hole. In some embodiments, the magnetic circuit assembly 336 includes a magnetic conductive plate 3361, the first magnet 331, and an accommodation member 3363. The magnetic conductive plate 3361 and the first magnet 331 are connected with each other. A side of the first magnet 331 facing away from the magnetic conductive plate 3361 is mounted on a bottom wall of the accommodation member 3363. There is a gap between a peripheral side of the first magnet 331 and an inner side wall of a peripheral side of the accommodation member 3363. In some embodiments, an outer side wall of the peripheral side of the accommodation member 3363 is connected and fixed to the bracket 334. In some embodiments, the accommodation member 3363 includes a bottom portion 3363a and a side wall 3363b along the peripheral side of the accommodation member 3363. The bottom portion 3363a and the side wall 3363b of the accommodation member enclose an accommodation space. The magnetic conductive plate 3361 and the first magnet 331 are accommodated within the accommodation space. The magnetic conductive plate 3361 and the first magnet 331 are connected to each other. A side of the first magnet 331 facing away from the magnetic conductive plate 3361 is mounted on the bottom portion 3363a of the accommodation member. A gap exists between the peripheral side of the first magnet 331 and the side wall 3363b of the peripheral side of the accommodation member 3363. In some embodiments, the first coil 333 extends into the gap between the first magnet 331 and the side wall 3363b.

In some embodiments, the first loudspeaker 330 serves as a low-frequency loudspeaker or a mid-low-frequency loudspeaker. Accordingly, a first sound output by the first loudspeaker 330 is a low-frequency sound or a mid-low-frequency sound. In some embodiments, the first loudspeaker 330 outputs a sound (e.g., the low-frequency sound or the mid-low-frequency sound) outward through a first front cavity and a first sound outlet hole disposed on the housing 310. In some embodiments, to ensure that the acoustic output device 300 is capable of outputting sounds in a full band, i.e., ensure that the acoustic output device 300 is capable of outputting a high-frequency sound while outputting the low-frequency sound or the mid-low-frequency sound, the acoustic output device 300 is provided with the second loudspeaker 340.

The second loudspeaker 340 is accommodated in the inner cavity formed by the housing 310. The second loudspeaker 340 may convert an electrical signal into a sound signal and output the sound signal. In some embodiments, the second loudspeaker 340 serves as a high-frequency loudspeaker. Accordingly, a second sound output by the second loudspeaker 340 is a high-frequency sound. In some embodiments, a frequency range of the first sound output by the first loudspeaker 330 and a frequency range of the second sound output by the second loudspeaker 340 are not overlapped. For example, a minimum frequency in the frequency range of the second sound is higher than a maximum frequency in the frequency range of the first sound. In some embodiments, the frequency range of the first sound output by the first loudspeaker 330 and the frequency range of the second sound output by the second loudspeaker 340 are overlapped. For example, the minimum frequency in the frequency range of the second sound does not exceed the maximum frequency in the frequency range of the first sound, and a maximum frequency in the frequency range of the second sound is higher than the maximum frequency in the frequency range of the first sound. In some embodiments, the following manner of defining a frequency band may be employed: considering that the first loudspeaker 330 may also output a relatively low high-frequency sound, a point of sound amplitude within a frequency band may be taken as a reference point, and a frequency point at which the amplitude is lower than a maximum amplitude point by more than a predetermined threshold may be regarded as a boundary of the frequency band. The predetermined threshold corresponds to a frequency point at which the amplitude is a certain proportion of the maximum amplitude point. For example, the frequency point corresponding to 5%, 10%, or 15% of the maximum amplitude point may be taken as such the boundary. It should be noted that the terms “low-frequency”, “mid-low-frequency”, and “high frequency” mentioned herein only indicate relative dimensions of frequencies. Different division methods may be used in different application scenarios. For example, a crossover frequency is determined. “Low-frequency” represents a frequency range below the crossover frequency, and “high frequency” represents a frequency range above the crossover frequency. The crossover frequency may be any value within an audible range of a human ear, for example, 500 Hz, 800 Hz, 1000 Hz, 2000 Hz, 4000 Hz, or 8000 Hz. Furthermore, it should be clarified that the terms “high-frequency” and “low-frequency” in the present disclosure are relative terms based on a comparative context; the term “high-frequency” refers to a frequency that is relatively higher than another frequency, and the term “low-frequency” refers to a frequency that is relatively lower than another frequency. For example, the first loudspeaker being a low-frequency loudspeaker and the second loudspeaker being a high-frequency loudspeaker refers to that, in comparison, the frequency of the sound output by the first loudspeaker is lower than that of the sound output by the second loudspeaker.

By setting the first loudspeaker 330 and the second loudspeaker 340 to be responsible for outputting sounds in different frequency ranges, respectively, for example, the first loudspeaker 330 outputs the low-frequency sound or the mid-low-frequency sound, and the second loudspeaker 340 outputs the high-frequency sound, the acoustic effect of the acoustic output device in a wider frequency band may be improved.

In some embodiments, the second loudspeaker 340 includes a second magnet 341 and a second diaphragm 342. The second magnet 341 and the second diaphragm 342 are spaced apart along a vibration direction of the second diaphragm 342. The second diaphragm 342 divides a cavity formed by a housing of the second loudspeaker 340 into a second front cavity and a second rear cavity. The second front cavity of the second loudspeaker 340 may be a cavity formed on a side of the second diaphragm 342 facing away from the second magnet 341 (also referred to as a front side of the second diaphragm 342). The second rear cavity of the second loudspeaker 340 may be a cavity formed on a side of the second diaphragm 342 facing the second magnet 341 (also referred to as a rear side of the second diaphragm 342) or on a side of the second magnet 341 facing away from the second diaphragm 342. The second magnet 341 is configured to generate a magnetic field. When the second diaphragm 342 vibrates, sounds are generated on the front side and the rear side of the second diaphragm 342, respectively. The sound generated on the front side of the second diaphragm 342 is radiated outward through the second front cavity and a second sound outlet hole that is in acoustic communication with the second front cavity. In some embodiments, the first sound outlet hole and the second sound outlet hole are two different sound outlet holes. The first sound outlet hole is configured to radiate the sound generated by the first loudspeaker 330 to the outside, and the second sound outlet hole is configured to radiate the sound generated by the second loudspeaker 340 to the outside. In other words, the first loudspeaker 330 and the second loudspeaker 340 do not share the same sound outlet hole. The first front cavity of the first loudspeaker 330 and the second front cavity of the second loudspeaker 340 are not in communication with each other.

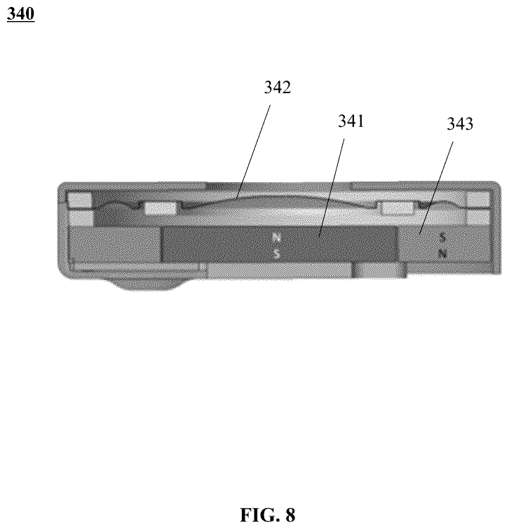

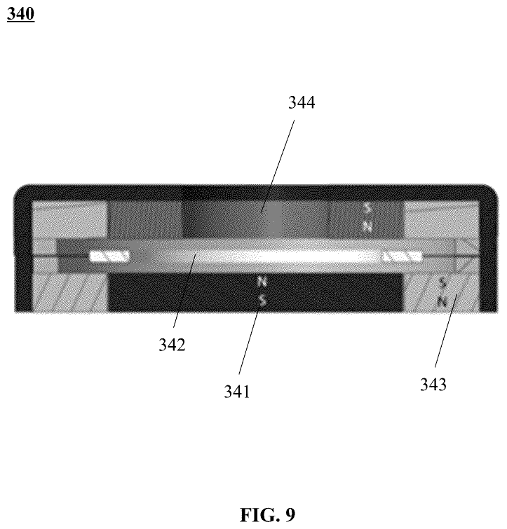

In some embodiments, the second loudspeaker 340 includes a second coil and a magnetic circuit assembly. After a current is applied to the second coil, the magnetic circuit assembly exerts a force on the energized second coil. The second coil vibrates under the action of a magnetic field and drives the second diaphragm 342 to generate mechanical vibration. A sound is then generated through the propagation of a medium such as air. In some embodiments, the magnetic circuit assembly of the second loudspeaker 340 includes one or more magnets. For example, the magnetic circuit assembly of the second loudspeaker 340 includes the second magnet 341. As another example, to increase a magnetic field strength at the second coil, a third magnet is disposed around a peripheral side of the second magnet 341. The second magnet 341 and the third magnet may form a magnetic circuit, and the second coil is disposed in the magnetic circuit. As another example, the magnetic circuit assembly of the second loudspeaker 340 further includes a fourth magnet. For specific arrangement manners of different counts of magnets in the magnetic circuit assembly, reference may be made to other parts of the present disclosure, e.g., FIG. 8 and FIG. 9, and the related descriptions thereof. It should also be noted that, as a high-frequency loudspeaker, to ensure a small dimension of the second loudspeaker 340, the magnetic circuit assembly of the second loudspeaker 340 may not include an accommodation member. Specifically, in some embodiments, the second loudspeaker 340 includes a spacing plate (not shown in the figure). The spacing plate is configured to support the magnetic circuit assembly of the second loudspeaker 340 and cooperate with the housing 310 to fix the second loudspeaker 340. In some embodiments, the spacing plate is a metal member with magnetic permeability and is connected to the housing 310 by embedding, snapping, or other means.

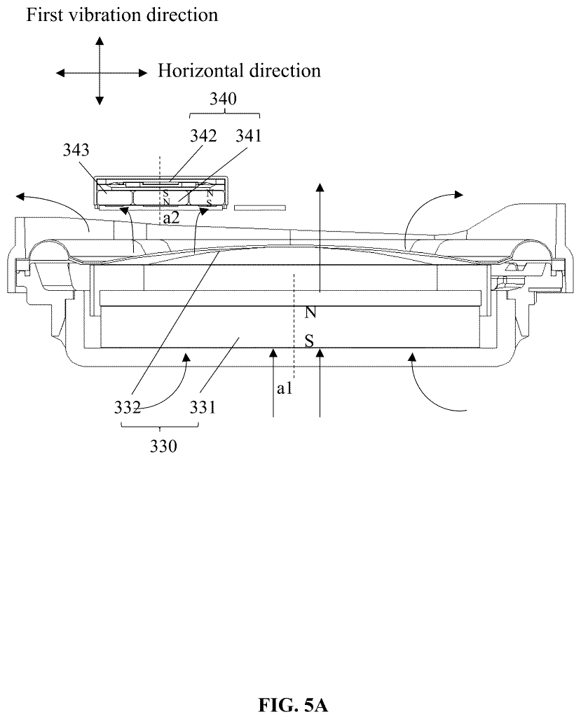

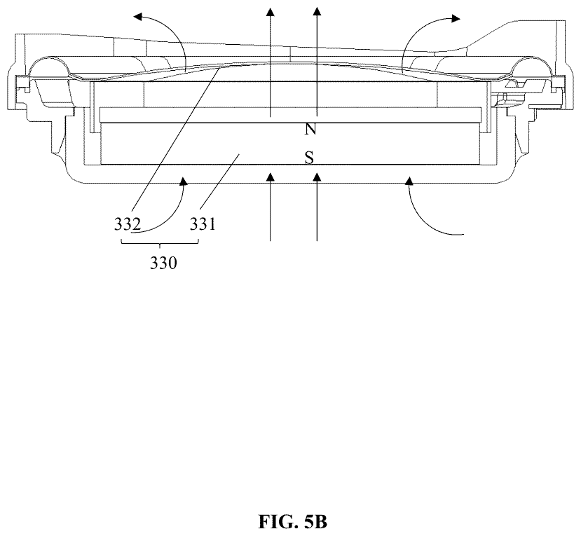

FIG. 5A is a schematic diagram illustrating a positional relationship between a first loudspeaker and a second loudspeaker according to some embodiments of the present disclosure. Referring to FIG. 5A, the first loudspeaker 330 and the second loudspeaker 340 may be stacked and spaced apart along a vibration direction of the first diaphragm 332 (a first vibration direction shown in FIG. 5A) or a second vibration direction of the second diaphragm 342. In this case, the first magnet 331 and the second magnet 341 are spaced apart along the vibration direction of the first diaphragm 332. In some embodiments, the first vibration direction of the first diaphragm 332 is parallel to the second vibration direction of the second diaphragm 342. The vibration direction of the first diaphragm 332 is parallel to an axis of the first magnet 331. The vibration direction of the second diaphragm 342 is parallel to an axis of the second magnet 341. In some embodiments, the axis of the first magnet 331 and the axis of the second magnet 341 form an angle. For example, the angle is 1°, 5°, 10°, or 30°. In this case, the vibration direction of the first diaphragm 332 and the vibration direction of the second diaphragm 342 also form an angle, correspondingly. A magnet (e.g., the first magnet 331 and the second magnet 341) has a south pole (S pole) and a north pole (N pole). An axis of the magnet refers to a polarization direction of the magnet or a direction where a symmetry axis of the magnet is located.

In some embodiments, identical magnetic poles of the first magnet 331 and the second magnet 341 are disposed opposite to each other. For example, as shown in FIG. 5A, the N pole of the first magnet 331 is disposed opposite to the N pole of the second magnet 341. As another example, the S pole of the first magnet 331 is disposed opposite to the S pole of the second magnet 341. In this case, a repulsive force is generated between the first magnet 331 and the second magnet 341. A first magnetic field and a second magnetic field are mutually coupled, which manifests as the second magnetic field generated by the second magnet 341 affecting the distribution of the first magnetic field generated by the first magnet 331. For example, compared to a case where only the first magnet 331 is provided (magnetic flux lines in the case where only the first magnet 331 is disposed are shown in FIG. 5B), in FIG. 5A, referring to magnetic flux lines shown in FIG. 5A, the second magnet 341 may suppress a diffusion degree of magnetic flux lines radiated by the first magnet 331 into space, so that a lot of the magnetic flux lines radiated by the N pole of the first magnet 331 into space are “confined” near the first coil, thereby increasing a magnetic field strength at the first coil of the first loudspeaker 330 and improving the sensitivity of the first loudspeaker 330. At the same time, the first magnetic field generated by the first magnet 331 also affects the distribution of the second magnetic field generated by the second magnet 341, thereby increasing a magnetic field strength at the second coil of the second loudspeaker 340 and improving the sensitivity of the second loudspeaker 340.

In the embodiment shown in FIG. 5A, the repulsive force between the first magnet 331 and the second magnet 341 may be greater than 0.08 N. A process for testing the repulsive force value between the first magnet 331 and the second magnet 341 is as follows. First, a fixture is fabricated to fix the first magnet 331 and the second magnet 341 at a relative position according to an actual distance. Then, one of the first magnet 331 and the second magnet 341 is connected to a spring dynamometer, and the fixture is removed to observe a reading on the dynamometer. Finally, the repulsive force between the first magnet 331 and the second magnet 341 is determined based on the dynamometer reading.

In some embodiments, the axis of the first magnet 331 and the axis of the second magnet 341 are spaced apart. As shown in FIG. 5A, the axis of the first magnet 331 is a1, and the axis of the second magnet 341 is a2, a1 and a2 being spaced apart may be understood as a1 and a2 being not coinciding. The axis a1 of the first magnet 331 and the axis a2 of the second magnet 341 are parallel to each other and spaced apart. By arranging the axis a1 of the first magnet 331 to be parallel to the axis a2 of the second magnet 341, the effect of the second magnet 341 suppressing magnetic leakage of the first magnet 331 may be improved, i.e., the effect of the second magnet 341 confining the magnetic flux lines radiated by the first magnet 331 is enhanced, thereby increasing the magnetic flux intensity at the first coil of the first loudspeaker 330. By arranging the axis a1 of the first magnet 331 to be spaced apart from the axis a2 of the second magnet 341, the second loudspeaker 340 may avoid, along the first vibration direction, a region of the first diaphragm 332 closest to the second loudspeaker 340, i.e., a central region of the first diaphragm 332 (e.g., a position where a dome-shaped portion of the first diaphragm 332 is located). Such an arrangement ensures that the second loudspeaker 340 does not contact the first diaphragm 332 during vibration (i.e., the second loudspeaker 340 does not affect the vibration of the first diaphragm 332). Based on this, a spacing between the second loudspeaker 340 and the first loudspeaker 330 may be further reduced, thereby increasing coupling between the first magnet 331 and the second magnet 341 and reducing the overall dimension of the acoustic output device 300.

FIG. 6A is a schematic diagram illustrating an exemplary wearing scenario of an acoustic output device according to some embodiments of the present disclosure. As shown in FIG. 6A, in some embodiments, in a wearing state, at least a portion of the housing 310 extends into a concha cavity of an ear, and at least a portion of a side surface of the housing 310 abuts against the concha cavity. In some embodiments, the housing 310 includes a connection end CE connected to the support structure 320 and a free end FE not connected to the support structure 320. Merely by way of example, with reference to FIG. 6A, in the wearing state, the free end FE of the housing 310 extends into the concha cavity. In some embodiments, the housing 310 and the support structure 320 may be arranged to jointly clamp an ear region corresponding to the concha cavity from front and rear sides of the ear region, respectively, thereby increasing the resistance of the acoustic output device 300 against falling off from the ear, and further improving the stability of the acoustic output device 300 in the wearing state. For example, the free end FE of the housing 310 presses against the concha cavity along a thickness direction X. As another example, the free end FE abuts against the concha cavity along a long-axis direction Y and/or a short-axis direction Z (e.g., abuts against an inner wall of the concha cavity that is opposite to the free end FE). The free end FE of the housing 310 refers to an end portion of the housing 310 disposed opposite to a fixed end that connects the support structure 320. The housing 310 may be a regular or irregular structure. For further illustration of the free end FE of the housing 310, an exemplary description is provided herein. For example, when the housing 310 is a cuboid structure, an end wall surface of the housing 310 is a plane. In this case, the free end FE of the housing 310 is an end side wall of the housing 310 disposed opposite to the fixed end that connects the support structure 320. As another example, when the housing 310 is a sphere, an ellipsoid, or an irregular structure, the free end FE of the housing 310 refers to a specific region obtained by cutting the housing 310 along a Y-Z plane (a plane formed by the short-axis direction Z and the thickness direction X) that is located away from the fixed end. It should be noted that, in the wearing state, besides extending into the concha cavity, the free end FE of the housing 310 may further have an orthogonal projection falling on an antihelix, or may have an orthogonal projection falling on the left and right sides of the head at a position in the front side of the ear along the sagittal axis. In other words, the support structure 320 may support the housing 310 to be worn at a wearing position such as the concha cavity, the antihelix, or the front side of the ear.

The acoustic output device 300 shown in FIG. 6A is taken as an example below for a detailed description. It should be understood that, without violating corresponding acoustic principles, the structure of the acoustic output device 300 in FIG. 6A and its corresponding parameters may also apply to other acoustic output devices of other configurations mentioned herein.

By extending at least a portion of the housing 310 into the concha cavity, a listening volume (especially a high-frequency listening volume) at a listening position (e.g., at an opening of an ear canal) may be increased, while still maintaining a desired far-field sound leakage cancellation effect. Merely by way of example, when an entirety or a portion of the housing 310 extends into the concha cavity, the housing 310 and the concha cavity form a structure similar to a cavity (hereinafter referred to as a cavity-like structure). In embodiments of the present disclosure, the cavity-like structure may be understood as a semi-enclosed structure jointly enclosed by a side wall of the housing 310 and the concha cavity, which is not completely sealed off from an external environment but has leakage structures (e.g., openings, gaps, pipes, etc.) that are in acoustic communication with the external environment. When a user wears the acoustic output device 300, one or more sound outlet holes may be disposed on a side wall of the housing 310 of the acoustic output device 300 that is close to or faces the ear canal of the user, and one or more pressure relief holes may be disposed on other side walls of the housing (e.g., a side wall that faces away from or opposite to the ear canal of the user). For example, when one sound outlet hole is disposed on the housing 310, the first loudspeaker 330 and the second loudspeaker 340 share the sound outlet hole. As another example, when two sound outlet holes are disposed on the housing 310, one sound outlet hole is configured to output a high-frequency sound, and the other sound outlet hole is configured to output a low-frequency sound or mid-low-frequency sound. As another example, when two or more sound outlet holes are disposed on the housing 310, a portion of the sound outlet holes are configured to output a high-frequency sound, and another portion of the sound outlet holes are configured to output a low-frequency sound or mid-low-frequency sound. Taking the scenario where the housing 310 includes one sound outlet hole and one pressure relief hole as an example, the sound outlet hole is acoustically coupled to a front cavity of an acoustic output device 300, and the pressure relief hole is acoustically coupled to a rear cavity of the acoustic output device 300. A sound output by the sound outlet hole and a sound output by the pressure relief hole may be approximately regarded as two sound sources (i.e., dual sound sources), and acoustic waves of the two sound sources have opposite phases. The housing 310 and an inner wall corresponding to the concha cavity form a cavity-like structure. A sound source corresponding to the sound outlet hole is located inside the cavity-like structure, and a sound source corresponding to the pressure relief hole is located outside the cavity-like structure, thereby forming an acoustic model shown in FIG. 6B.

FIG. 6B is a schematic diagram illustrating an exemplary distribution of a cavity structure arranged around one of dual sound sources according to some embodiments of the present disclosure. As shown in FIG. 6B, a cavity-like structure 502 includes a listening position and at least one sound source 501A. The term “includes” herein may indicate that at least one of the listening position or the sound source 501A is located inside the cavity-like structure 502, or located close to an inner edge of the cavity-like structure 502. The listening position may be equivalent to an entrance of an ear canal of an ear, or may be an acoustic reference point of the ear, e.g., an ear reference point (ERP), an ear-drum reference point (DRP), etc., or may be an entrance structure directed to a listener. Since the sound source 501A is wrapped by the cavity-like structure 502, most of the sounds radiated by the sound source 501A reach the listening position through direct radiation or reflection. In contrast, in a case where there is no cavity-like structure 502, most of the sounds radiated by the sound source 501A does not reach the listening position. Therefore, the arrangement of the cavity-like structure significantly increases a sound volume reaching the listening position. Meanwhile, only a small portion of anti-phase sounds radiated by an out-of-phase sound source 501B located outside the cavity-like structure 502 enters the cavity-like structure 502 through a leakage structure 503 of the cavity-like structure 502, which is equivalent to generating a secondary sound source 501B′ at the leakage structure 503. An intensity of the secondary sound source 501B′ is significantly less than an intensity of the sound source 501B, and is also significantly less than an intensity of the sound source 501A. A sound generated by the secondary sound source 501B′ produces only a slight out-of-phase cancellation effect on the sound source 501A within the cavity-like structure, thereby significantly increasing the listening volume at the listening position. For sound leakage, radiation of sounds from the sound source 501A to the outside through the leakage structure 503 of the cavity-like structure is equivalent to generating a secondary sound source 501A′ at the leakage structure 503. Since almost all sounds radiated by the sound source 501A are output by the leakage structure 503, and a scale of the cavity-like structure 502 is at least an order of magnitude smaller than a spatial scale for evaluating sound leakage, the intensity of the secondary sound source 501A′ may be considered to be equivalent to the intensity of the sound source 501A. For an external space, the secondary sound source 501A′ and the sound source 501B form dual sound sources for cancellation to reduce the sound leakage.

In a specific application scenario, an outer wall surface of the housing 310 is usually a plane or a curved surface, while a contour of the concha cavity 102 of the user is an uneven structure. By extending a portion or an entirety of the housing 310 into the concha cavity, a cavity-like structure in communication with the outside is formed between the housing 310 and the contour of the concha cavity. Further, by disposing a sound outlet hole at a position on the housing 310 that faces an opening of an ear canal of the user and is located close to an edge of the concha cavity 102, and disposing a pressure relief hole at a position on the housing 310 that faces away from the opening of the ear canal, the acoustic model shown in FIG. 6B may be constructed. Therefore, when the user wears the acoustic output device 300, a listening position at the opening of the ear canal of the user may be increased, and far-field sound leakage effect may be reduced.

In some embodiments, a first sound outlet hole and a second sound outlet hole are disposed on an inner side surface of the housing 310. In a wearing manner shown in FIG. 6A, the inner side surface of the housing 310 refers to a side surface of the housing 310 facing the opening of the ear canal in the wearing state. The first sound outlet hole is acoustically coupled to the first diaphragm 332. When the first diaphragm 332 vibrates, a sound generated on a side of the first diaphragm 332 facing away from the first magnet 331 is radiated outward through a first front cavity and the first sound outlet hole. The second sound outlet hole is acoustically coupled to the second diaphragm 342. When the second diaphragm 342 vibrates, a sound generated on a side of the second diaphragm 342 facing away from the second magnet 341 is radiated outward through a second front cavity and the second sound outlet hole. In some embodiments, the first front cavity of the first loudspeaker 330 and the second front cavity of the second loudspeaker 340 are not in acoustic communication with each other. The first loudspeaker 330 and the second loudspeaker 340 do not share the same sound outlet hole. That is, the first sound outlet hole is only configured to radiate a low-frequency sound or a mid-low-frequency sound generated when the first diaphragm 332 vibrates, and the second sound outlet hole is only configured to radiate a high-frequency sound generated when the second diaphragm 342 vibrates. By disposing the first sound outlet hole and the second sound outlet hole on the inner side surface of the housing 310, and enabling a sound generated by the first loudspeaker 330 to be radiated outward through the first sound outlet hole and a sound generated by the second loudspeaker 340 to be radiated outward through the second sound outlet hole (i.e., the two loudspeakers do not share the same sound outlet hole), a structure on an outer side of the second loudspeaker may be simplified (e.g., a thickness of the housing 310 is reduced). Typically, the second loudspeaker 340 is a pre-packaged structure, and the entirety of the second loudspeaker 340 is disposed in the first front cavity of the first loudspeaker 330. If the first loudspeaker 330 and the second loudspeaker 340 need to share the same sound outlet hole, it is equivalent to arranging the first sound outlet hole outside the second sound outlet hole (both two loudspeakers need to radiate sounds outward through the first sound outlet hole, and the first sound outlet hole is a shared sound outlet hole). Compared to a manner where the first sound outlet hole and the second sound outlet hole are spaced apart on the inner side surface of the housing 310 and do not share the same sound outlet hole, sharing the same sound outlet hole leads to a larger overall dimension of the acoustic output device 300 (especially a larger thickness of the housing 310). In addition, the two loudspeakers not sharing the same sound outlet hole may also prevent the sound radiated by the first loudspeaker 330 and the sound radiated by the second loudspeaker 340 from interfering with each other, thereby weakening mutual radiation impedance.

In some embodiments, a pressure relief hole is disposed on the housing 310. The pressure relief hole is acoustically coupled to the first diaphragm 332. When the first diaphragm 332 vibrates, a sound generated on a side of the first diaphragm 332 facing the first magnet 331 is radiated outward through a first rear cavity and the pressure relief hole. In some embodiments, the pressure relief hole is located on a side surface of the housing 310 adjacent to or opposite to the inner side surface of the housing 310. In some embodiments, the first loudspeaker 330 outputs a low-frequency sound, and an amplitude of vibration of the first diaphragm 332 is large, which causes sound pressures in the first front cavity and the first rear cavity of the first loudspeaker 330 to be high. By disposing the pressure relief hole on the housing 310, the pressure relief hole is configured to balance the sound pressures in the first front cavity and the first rear cavity, to ensure that air in the first rear cavity does not hinder the vibration of the first diaphragm 332, thereby ensuring that the first loudspeaker 330 can effectively output the low-frequency sound.

In some embodiments, an inner cavity formed by the housing 310 includes a first cavity and a second cavity separated from each other. The first loudspeaker 330 is accommodated within the first cavity, and the second loudspeaker 340 is accommodated within the second cavity. In some embodiments, a partition plate is disposed in the housing 310. The partition plate separates the inner cavity formed by the housing 310 into the first cavity accommodating the first loudspeaker 330 and the second cavity accommodating the second loudspeaker 340. In this case, the first diaphragm 332 of the first loudspeaker 330 separates the first cavity into a first front cavity and a first rear cavity. The first front cavity is acoustically coupled to the first sound outlet hole. A sound generated on a front side of the first diaphragm 332 is radiated outward through the first front cavity and the first sound outlet hole. The second diaphragm 342 of the second loudspeaker 340 separates the second cavity into a second front cavity and a second rear cavity. The second front cavity is acoustically coupled to the second sound outlet hole. A sound generated on a front side of the second diaphragm 342 is radiated outward through the second front cavity and the second sound outlet hole. In some embodiments, the partition plate may be a circuit board carrying electronic elements in the second loudspeaker 340 or a magnetic conductive member in a magnetic circuit assembly. The first loudspeaker 330 and the second loudspeaker 340 do not share the same cavity. That is, there is no acoustic conduction formed between the first diaphragm 332 and the second diaphragm 342 (i.e., the first front cavity of the first loudspeaker 330 and the second front cavity of the second loudspeaker 340 are not in acoustic communication with each other, and the first loudspeaker 330 and the second loudspeaker 340 do not share the same sound outlet hole). Such an arrangement may prevent the sound radiated by the first loudspeaker 330 and the sound radiated by the second loudspeaker 340 from interfering with each other, thereby weakening the mutual radiation impedance.

In some embodiments, in the wearing state, the second sound outlet hole is located closer to the opening of the ear canal than the first sound outlet hole, i.e., a sound outlet hole corresponding to a high-frequency loudspeaker is closer to the opening of the ear canal. Merely by way of example, in the wearing state, an orthogonal projection of a centroid of the second sound outlet hole on the sagittal plane is closer to the opening of the ear canal than an orthogonal projection of a centroid of the first sound outlet hole on the sagittal plane. The orthogonal projection refers to a projection obtained on a projection plane by projecting along a projection direction perpendicular to the projection plane. Corresponding to this embodiment, the projection plane herein is the sagittal plane, and the projection direction is a direction where the coronal axis is located. Since a high-frequency sound output by the second loudspeaker 340 has strong directivity, by disposing the second sound outlet hole closer to the opening of the ear canal, a listening volume of the high-frequency sound output by the second loudspeaker may be increased, thereby improving the sound effect of the acoustic output device 300. In some embodiments, the first sound outlet hole is arranged around the second sound outlet hole to ensure that the acoustic output device 300 may output sounds in a full band.

It should be known that, since the first sound outlet hole and the second sound outlet hole are disposed on the housing, and each side wall of the housing has a certain thickness, the first sound outlet hole and the second sound outlet hole are holes with a certain depth. In this case, both the first sound outlet hole and the second sound outlet hole may have an inner opening and an outer opening. For ease of description, in embodiments of the present disclosure, the centroid of the first sound outlet hole and the centroid of the second sound outlet hole refer to a centroid of the outer opening of the first sound outlet hole and a centroid of the outer opening of the second sound outlet hole, respectively.

In some embodiments, in the wearing state, a center of the second magnet 341 is closer to the opening of the ear canal than a center of the first magnet 331. Merely by way of example, in the wearing state, an orthogonal projection of the center of the second magnet 341 on the sagittal plane is closer to the opening of the ear canal than an orthogonal projection of the center of the first magnet 331 on the sagittal plane. A center of a magnet refers to a centroid of an end surface of the magnet facing a diaphragm. By disposing the center of the second magnet 341 closer to the opening of the ear canal, a sound output when the second diaphragm 342 of the second loudspeaker vibrates may reach the opening of the ear canal after propagating a shorter distance, thereby increasing the listening volume of the high-frequency sound output by the second loudspeaker and improving the sound effect of the acoustic output device 300.

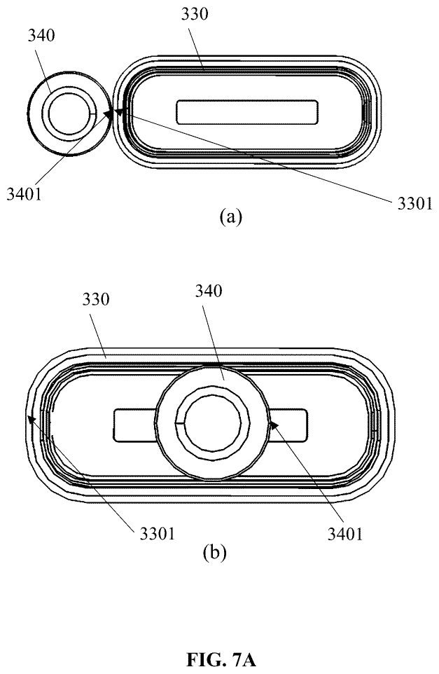

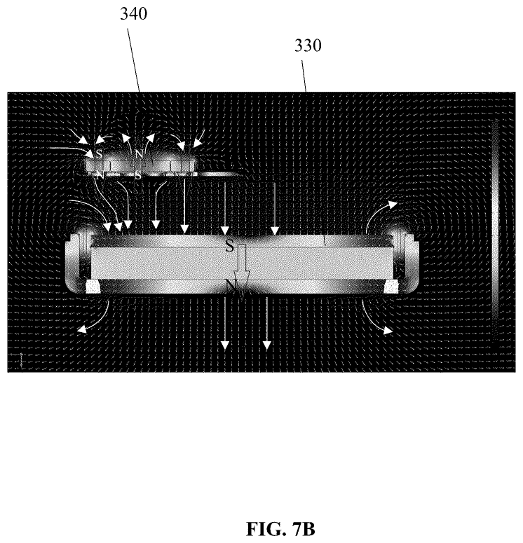

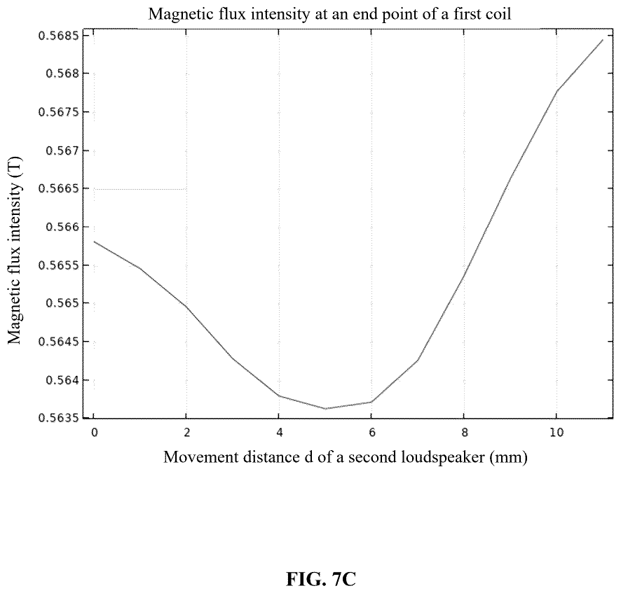

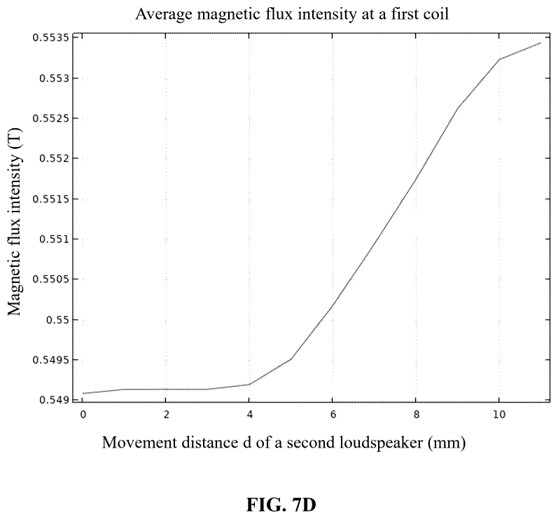

By setting a relative position between the first magnet 331 and the second magnet 341 along a direction perpendicular to a vibration direction of a diaphragm (e.g., a horizontal direction shown in FIG. 5A), an enhancement effect of a coupling relationship between magnetic fields of the first magnet 331 and the second magnet 341 on a magnetic flux intensity at a first coil of the first loudspeaker may be ensured, thereby increasing a radiation sound pressure level of the first loudspeaker. In some embodiments, on a plane where a surface of the first magnet 331 facing the first diaphragm 332 is located (i.e., a reference plane perpendicular to the vibration direction of the first diaphragm 332), an orthogonal projection of the second magnet 341 and an orthogonal projection of the first magnet 331 are at least partially overlapped, so that a second magnetic field generated by the second magnet 341 may enhance a magnetic flux intensity at the first coil located in a first magnetic field generated by the first magnet 331. That is, the second magnetic field generated by the second loudspeaker 340 enhances the first magnetic field generated by the first loudspeaker 330, thereby increasing a sound pressure level of a low-frequency sound output by the first loudspeaker 330. Further, as may be seen from FIG. 7D, an average magnetic flux intensity at the first coil varies as a movement distance of the second loudspeaker 340 along a horizontal direction (as described in FIG. 5A). Therefore, an overlapping area between the orthogonal projection of the second magnet 341 and the orthogonal projection of the first magnet 331 affects the average magnetic flux intensity at the first coil. A larger overlapping area between the orthogonal projection of the second magnet 341 and the orthogonal projection of the first magnet 331 (a maximum overlapping area equals to an area of the larger orthogonal projection between the first magnet 331 and the second magnet 341) results in a larger average magnetic flux intensity at the first coil. For a more detailed description of FIG. 7D, please refer to the following.

The relative position between the first diaphragm 332 and the second diaphragm 342 along the direction perpendicular to the vibration direction (e.g., the horizontal direction shown in FIG. 5A) may determine a relative position between the first magnet 331 and the second magnet 341, which in turn affects a coupling condition between the first magnetic field generated by the first loudspeaker 330 and the second magnetic field generated by the second loudspeaker 340. In some embodiments, on the plane where the surface of the first magnet 331 facing the first diaphragm 332 is located (i.e., the reference plane perpendicular to the vibration direction of the first diaphragm 332), an orthogonal projection of the second diaphragm 342 and an orthogonal projection of the first diaphragm 332 are at least partially overlapped. In this case, a distance between the first diaphragm 332 and the second diaphragm 342 along the direction perpendicular to the vibration direction is not too large. Such an arrangement enables the second magnetic field generated by the second magnet to enhance the magnetic flux intensity at the first coil located in the first magnetic field generated by the first magnet. That is, the second magnetic field generated by the second loudspeaker 340 enhances the first magnetic field generated by the first loudspeaker, thereby improving the sound pressure level of the low-frequency sound output by the first loudspeaker 340. The plane where the surface of the first magnet 331 facing the first diaphragm 332 is located may be regarded as a projection plane of the first diaphragm 332 and the second diaphragm 342.

In some embodiments, the plane where the surface of the first magnet 331 facing the first diaphragm 332 is located is determined based on a three-dimensional model of an acoustic output device. An orthogonal projection may be performed on the plane to determine a positional relationship between the orthogonal projection of the first magnet 331 and the orthogonal projection of the second magnet 341.

Referring to FIG. 4, in some embodiments, the first diaphragm 332 includes a main body region 3321 and a folded annular region 3322 surrounding the main body region 3321. The main body region 3321 is fixedly connected to the first loudspeaker 330 through the folded annular region 3322. In some embodiments, the main body region 3321 includes a dome-shaped portion 3321c, and the dome-shaped portion 3321c protrudes toward a side away from the first magnet 331. The dome-shaped portion 3321c has high strength and stiffness, which suppresses the split vibration of the main body region 3321 to a certain extent, thereby improving vibration characteristics of the first loudspeaker 330.

In some embodiments, the dome-shaped portion 3321c and the folded annular region 3322 are directly connected. For example, the folded annular region 3322 includes an inner edge close to the dome-shaped portion 3321c and an outer edge away from the dome-shaped portion 3321c. The dome-shaped portion 3321c and the inner edge of the folded annular region 3322 are directly connected. In some embodiments, the dome-shaped portion 3321c and the folded annular region 3322 are indirectly connected. For example, the main body region 3321 further includes a first inclined segment 3321a and a first connecting segment 3321b. The first inclined segment 3321a connects the main body region 3321 and the folded annular region 3322. The first connecting segment 3321b connects the first inclined segment 3321a and the dome-shaped portion 3321c. The first connecting segment 3321b is configured to connect the first coil 333, and an extension direction of the first connecting segment 3321b is perpendicular to the vibration direction of the first diaphragm 332. The first inclined segment 3321a fits a portion of the folded annular region 3322. The first coil 333 is located on a lower side of the first connecting segment 3321b. The first inclined segment 3321a is inclined relative to the first connecting segment 3321b along a direction away from the first coil 333. With the above arrangement, adhesive used for bonding the first coil 333 to the first diaphragm 332 may be prevented from overflowing to the folded annular region 3322, which may otherwise affect vibration performance of the first diaphragm 332 due to the adhesive corroding the folded annular region 3322.

In some embodiments, a projection of a center of the second magnet 341 of the second loudspeaker 340 on the first diaphragm 332 along an axis of the second magnet 341 is located between a center of the dome-shaped portion 3321c and the inner edge of the folded annular region 3322. The center of the dome-shaped portion 3321c refers to a centroid of the dome-shaped portion 3321c. For example, the center of the dome-shaped portion 3321c is located at a highest point of the dome-shaped portion 3321c (i.e., a point on the dome-shaped portion 3321c farthest from the first magnet 331). By setting a relative position between the first magnet 331 and the second magnet 341 along a direction perpendicular to the vibration direction of the first diaphragm 332 and the second diaphragm 342 (i.e., the projection of the center of the second magnet 341 on the first diaphragm 332 along the axis of the second magnet 341 is located between the center of the dome-shaped portion 3321c and the inner edge of the folded annular region 3322), mutual enhancement between the first magnetic field and the second magnetic field may be ensured, thereby improving a radiation sound pressure level of the two loudspeakers. In addition, both the center of the dome-shaped portion 3321c and the folded annular region 3322 are regions on the first diaphragm 332 that are relatively high in position. Setting the projection of the center of the second magnet 341 on the first diaphragm 332 along the axis of the second magnet 341 to be located between the center of the dome-shaped portion 3321c and the inner edge of the folded annular region 3322 may offset the second loudspeaker 340 from the two higher regions (i.e., the center of the dome-shaped portion 3321c and the folded annular region 3322), which facilitates reducing the distance between the first loudspeaker 330 and the second loudspeaker 340, thereby reducing the overall dimension of the acoustic output device 300. In addition, such an arrangement may also prevent the first diaphragm (especially the dome-shaped portion 3321c) from colliding with the second loudspeaker during vibration.

In some embodiments, there is a first distance between a magnetic circuit system where the first magnet 331 is located and a magnetic circuit system where the second magnet 341 is located along the vibration direction of the first diaphragm 332. The magnetic circuit system refers to a magnetic circuit assembly. The first distance refers to a distance between a bottom of the magnetic circuit system of the second loudspeaker 340 facing away from the second diaphragm 342 (e.g., a surface of the second magnet 341 facing away from the second diaphragm 342) and a top of the magnetic circuit system of the first loudspeaker 330 (e.g., a surface of a magnetic conductive plate in the magnetic circuit assembly facing the first diaphragm 332).

In some embodiments, to ensure that the second loudspeaker 340 does not collide with the first diaphragm 332 during vibration, the first distance is greater than 2.85 mm. In some embodiments, to ensure that the dimension of the acoustic output device 300 is not too large, the first distance is less than 3.42 mm. In some embodiments, to balance the vibration of the first diaphragm and the dimension of the acoustic output device, the first distance is in a range of 2.85 mm to 3.42 mm. In some embodiments, the first distance tends to affect a coupling condition between the first magnetic field generated by the first loudspeaker 330 and the second magnetic field generated by the second loudspeaker 340. By setting the first distance in an appropriate range, the mutual enhancement between the first magnetic field and the second magnetic field may be ensured, which improves a radiation sound pressure level of the two loudspeakers. In some embodiments, to ensure the mutual enhancement between the first magnetic field and the second magnetic field to improve the radiation sound pressure level of the two loudspeakers, and to ensure the stable vibration of the first diaphragm 332, the first distance is in a range of 3 mm to 3.2 mm.

In some embodiments, there is a second distance between the first magnet 331 and the second magnet 341 along the vibration direction of the first diaphragm 332. For example, the second distance may be a distance between a bottom of the second magnet 341 (a side of the second magnet 341 facing away from the second diaphragm 342) and a top of the first magnet 331 (a side of the first magnet 331 facing the first diaphragm 332).

In some embodiments, the second distance tends to affect a coupling condition between the first magnetic field generated by the first loudspeaker 330 and the second magnetic field generated by the second loudspeaker 340. By setting the second distance in an appropriate range, the mutual enhancement between the first magnetic field and the second magnetic field may be ensured, which improves the radiation sound pressure level of the two loudspeakers. In some embodiments, to ensure the mutual enhancement between the first magnetic field and the second magnetic field to improve the radiation sound pressure level of the two loudspeakers, the second distance is in a range of 3.06 mm to 4.58 mm. In some embodiments, the second distance is in a range of 3.6 mm to 4.0 mm. In some embodiments, the second distance is in a range of 3.80 mm to 3.85 mm.

In some embodiments, the relative position between the first loudspeaker 330 and the second loudspeaker 340 along the horizontal direction (i.e., the direction perpendicular to the vibration direction) tends to affect the coupling condition between the first magnetic field and the second magnetic field, which in turn affects a magnetic flux intensity at the first coil of the first loudspeaker 330 and a magnetic flux intensity at the second coil of the second loudspeaker 340. FIG. 7A is a schematic diagram illustrating different relative positions between a first loudspeaker and a second loudspeaker along a horizontal direction according to some embodiments of the present disclosure. FIG. 7B is a schematic diagram illustrating a distribution of magnetic fields of a first loudspeaker and a second loudspeaker along a horizontal direction according to some embodiments of the present disclosure. FIG. 7C is a trend graph illustrating a change in a magnetic flux intensity at an end point of a first coil of a first loudspeaker when the first loudspeaker and a second loudspeaker are located in different relative positions along a horizontal direction according to some embodiments of the present disclosure. FIG. 7D is a trend graph illustrating a change in an average magnetic flux intensity at a first coil according to some embodiments of the present disclosure. It should be noted that FIGS. 7A, 7B, 7C, and 7D show the second loudspeaker 340 with a dual-magnet configuration (i.e., including the second magnet 341 and a third magnet 343). For specific content of the dual-magnet configuration, please refer to the related description of FIG. 8. However, whether the second loudspeaker 340 has a single-magnet configuration (i.e., only including the second magnet 341) or the dual-magnet configuration, similar conclusions may be drawn regarding the relative position between the first loudspeaker 330 and the second loudspeaker 340 along the horizontal direction. As shown in FIG. 7A, under the premise that a spacing between the second loudspeaker 340 and the first loudspeaker 330 along the vibration direction of the first diaphragm 332 remains unchanged, (a) in FIG. 7A illustrates a positional relationship where the second loudspeaker 340 is located outside the first loudspeaker 330 along the direction perpendicular to the vibration direction of the first diaphragm 332. In (a) of FIG. 7A, a distance between a first end portion 3301 on the first loudspeaker 330 and a second end portion 3401 on the second loudspeaker 340 is 0 mm. The first end portion 3301 refers to an end portion of the first loudspeaker 330 that is closest to the second loudspeaker 340. Similarly, the second end portion 3401 refers to an end portion of the second loudspeaker 340 that is closest to the first loudspeaker 330. In this case, projections of the second loudspeaker 340 and the first loudspeaker 330 are not overlapped on a reference plane perpendicular to the vibration direction of the first diaphragm 332, which may be understood as a case where a movement distance of the second loudspeaker 340 is 0 mm in FIG. 7C. (b) in FIG. 7A illustrates a positional relationship where the second loudspeaker 340 is located directly opposite a center of the first loudspeaker 330 on the reference plane perpendicular to the vibration direction of the first diaphragm 332. In this case, the distance between the first end portion 3301 and the second end portion 3401 increases. With reference to FIGS. 7A to 7C, when the second loudspeaker 340 is located outside the first loudspeaker 330, at an end point of the first coil, a direction of magnetic flux lines of a side magnet of the second loudspeaker 340 (i.e., the third magnet 343) is opposite to a direction of magnetic flux lines of a first magnetic field generated by the first loudspeaker 330. Therefore, as the second loudspeaker 340 moves toward a central position of the first loudspeaker 330, a magnetic flux intensity at the end point of the first coil of the first loudspeaker 330 decreases. As the second loudspeaker 340 continues to move, at the first coil of the first loudspeaker 330, the direction of the magnetic flux lines of the side magnet of the second loudspeaker 340 reverses relative to an initial direction of the magnetic flux lines of the side magnet. Therefore, as the movement distance of the second loudspeaker 340 increases, the magnetic flux intensity at the end point of the first coil increases. When the second loudspeaker 340 moves to a position located directly opposite the center of the first loudspeaker 330, the average magnetic flux intensity at the first coil is maximized.

Referring to FIG. 7D, FIG. 7D illustrates a relationship between the average magnetic flux intensity at the first coil and the movement distance of the second loudspeaker 340 along the horizontal direction. In FIG. 7D, a horizontal coordinate represents the movement distance d of the second loudspeaker 340 in mm, and a vertical coordinate represents the average magnetic flux intensity at the first coil in T. A movement process of the second loudspeaker 340 here may be a process of moving from the position shown in (a) in FIG. 7A to the position shown in (b) in FIG. 7A. When the movement distance of the second loudspeaker 340 is less than 4 mm, the average magnetic flux intensity at the first coil does not change significantly. This is because, along the horizontal direction, the second loudspeaker 340 has two magnetic fields along opposite directions (see FIG. 7B), and the two magnetic fields affect the magnetic flux intensity at the end point of the first coil. When the movement distance of the second loudspeaker 340 is small, effects of the two magnetic fields are substantially the same and thus cancel each other out, resulting in a substantially unchanged average magnetic flux intensity at the first coil. As the movement distance of the second loudspeaker 340 increases (greater than 4 mm), the second loudspeaker 340 moves closer to the center of the first loudspeaker 330, the side magnet of the second loudspeaker 340 enhances the magnetic field at the first coil, thereby a accelerating a growth rate and increasing a growth amplitude of the average magnetic flux intensity at the first coil.

It should be noted that, in principle, the average magnetic flux intensity at the first coil is maximized when the second loudspeaker 340 is located at the center of the first loudspeaker 330. However, in practical applications, considering factors such as the dimension of the acoustic output device 300, the distance between the second sound outlet hole of the second loudspeaker 340 and the opening of the ear canal, and the magnetic field strength, the position located directly opposite the center of the first loudspeaker 330 may not be an optimal position for the second loudspeaker 340. For example, in the structure and wearing state shown in FIG. 6A, a distance between the position located directly opposite the center of the first loudspeaker 330 as shown in (b) in FIG. 7A and the opening of the ear canal is relatively far, and there is a risk that the second speaker 340 may be blocked by the tragus.

In some embodiments, the relative position between the second loudspeaker 340 and the first loudspeaker 330 along the horizontal direction may be characterized by a distance between an orthogonal projection of a centroid of the first diaphragm 332 and an orthogonal projection of a centroid of the second diaphragm 342 on a plane where a surface of the first magnet 331 facing the first diaphragm 332 is located. Considering the above, to balance the average magnetic flux intensity at the first coil, the dimension of the acoustic output device 300, and the distance between the second sound outlet hole of the second loudspeaker 340 and the opening of the ear canal, the distance between the orthogonal projection of the centroid of the first diaphragm 332 and the orthogonal projection of the centroid of the second diaphragm 342 on the plane where the surface of the first magnet 331 facing the first diaphragm 332 is located may be in a range of 0 mm to 8 mm.

FIG. 8 is a schematic diagram illustrating an exemplary structure of a second loudspeaker according to some embodiments of the present disclosure. Referring to FIG. 8, in some embodiments, the second loudspeaker 340 further includes the third magnet 343. The third magnet 343 is arranged surrounding the second magnet 341. For example, the third magnet 343 is an annular magnet, and the annular magnet is arranged surrounding a peripheral side of the second magnet 341.

In some embodiments, identical magnetic poles of the third magnet 343 and the second magnet 341 are oriented in opposite directions. For example, as shown in FIG. 8, the N pole of the second magnet 341 faces the second diaphragm 342, while the S pole of the third magnet 343 faces the second diaphragm 342. With this arrangement, on the one hand, a magnetic field generated by the third magnet 343 may increase a magnetic field strength at a second coil of the second loudspeaker 340. On the other hand, more magnetic flux lines emitted from the N pole of the second magnet 341 may be received by the S pole of the third magnet 343, i.e., the third magnet 343 may increase the magnetic field strength of the second magnet 341 at the second coil.

FIG. 9 is a schematic diagram illustrating another exemplary structure of a second loudspeaker according to some embodiments of the present disclosure. Referring to FIG. 9, in some embodiments, the second loudspeaker 340 further includes a fourth magnet 344. The fourth magnet 344 and the second magnet 341 are arranged along a vibration direction of the second diaphragm 342, and identical magnetic poles of the fourth magnet 344 and the second magnet 341 are disposed opposite to each other. As shown in FIG. 9, the N pole of the fourth magnet 344 and the N pole of the second magnet 341 are disposed opposite to each other. With this arrangement, more magnetic flux lines may vertically pass through the second coil, so as to increase a magnetic flux intensity at the second coil and suppress magnetic leakage, thereby increasing the sensitivity of the second loudspeaker 340. It should be noted that, when the second loudspeaker 340 includes the fourth magnet 344, a configuration (e.g., a diameter) of the second magnet 341 and the third magnet 343 is the same as a configuration when the second loudspeaker 340 includes only the second magnet 341 and the third magnet 343.

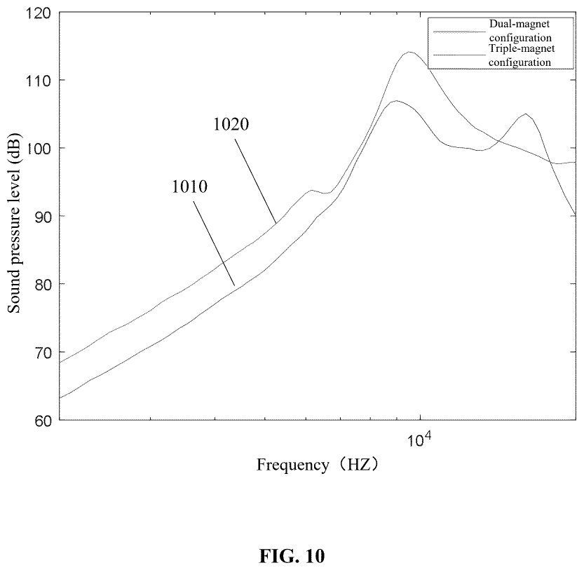

FIG. 10 is a graph illustrating curves of sound pressure levels of a second loudspeaker with a dual-magnet configuration and with a triple-magnet configuration according to some embodiments of the present disclosure. The dual-magnet configuration refers to a configuration where the second loudspeaker 340 includes two magnets. For example, the second loudspeaker 340 shown in FIG. 8 includes the second magnet 341 and the third magnet 343. The triple-magnet configuration refers to a configuration where the second loudspeaker 340 includes three magnets. For example, the second loudspeaker 340 shown in FIG. 9 includes the second magnet 341, the third magnet 343, and the fourth magnet 344. In FIG. 10, a horizontal coordinate represents frequency in Hz, and a vertical coordinate represents a sound pressure level in dB. A curve 1010 represents a sound pressure level of the second loudspeaker 340 having the dual-magnet configuration with the second magnet 341 and the third magnet 343. A curve 1020 represents a sound pressure level of the second loudspeaker 340 having the triple-magnet configuration with the second magnet 341, the third magnet 343, and the fourth magnet 344. As may be seen from FIG. 10, across the overall frequency range, the second loudspeaker with the triple-magnet configuration has a higher sensitivity compared to the second loudspeaker with the dual-magnet configuration. The sensitivity of the second loudspeaker with the triple-magnet configuration is about 6 dB higher than the sensitivity of the second loudspeaker with the dual-magnet configuration. That is, compared to the case where the fourth magnet 344 is not provided (i.e., the dual-magnet configuration), arranging the fourth magnet 344 in the above manner (i.e., setting the triple-magnet configuration) allows more magnetic flux lines to vertically pass through the second coil, increases the magnetic flux intensity at the second coil, and suppresses magnetic leakage, thereby improving the sensitivity of the second loudspeaker.

In some embodiments, when identical magnetic poles of the first magnet 331 of the first loudspeaker 330 and the second magnet 341 of the second loudspeaker 340 are disposed opposite to each other, and the third magnet 343 is arranged surrounding the second magnet 341, the magnetic field generated by the second magnet 341 may enhance the magnetic flux intensity at the first coil of the first loudspeaker 330, while the magnetic field generated by the third magnet 343 reduces the magnetic flux intensity at the first coil. Since the effects of the second magnet 341 and the third magnet 343 on the magnetic flux intensity at the first coil are opposite, it is necessary to reasonably set dimensions of the second magnet 341 and the third magnet 343, so as to ensure the output performance of the second loudspeaker 340 and enable a combined magnetic field of the second loudspeaker 340 (e.g., a magnetic field obtained by coupling the magnetic field generated by the second magnet 341 and the magnetic field generated by the third magnet 343) to enhance the magnetic flux intensity at the first coil. In this embodiment, a dimension of a magnet may be characterized by an area of a cross-section of the magnet perpendicular to an axis of the magnet. For ease of description, a ratio of an area of a cross-section of the second magnet 341 along an axis of the second magnet 341 to an area of a cross-section of the third magnet 343 along an axis of the third magnet 341 is referred to as an area ratio of the second magnet 341 to the third magnet 343.

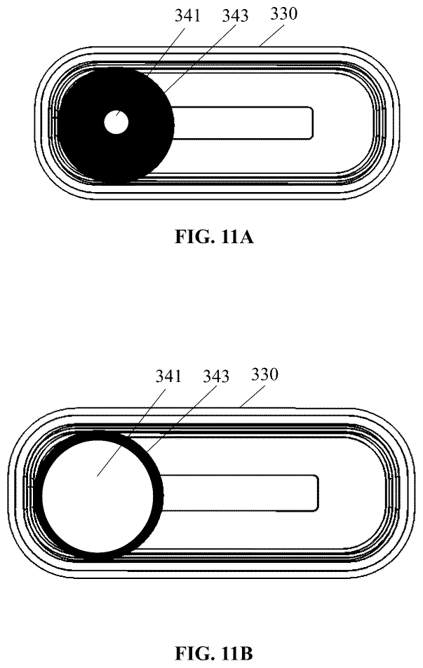

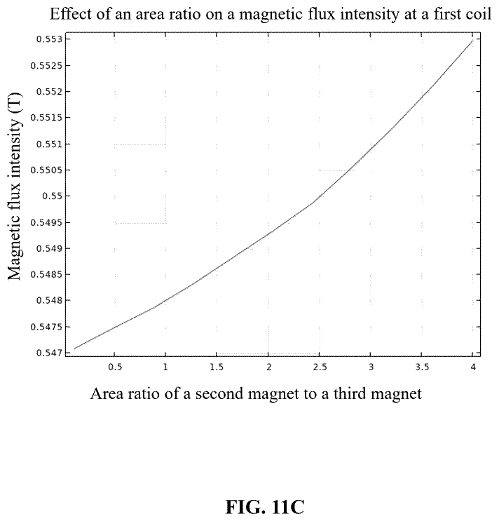

FIG. 11A is a schematic diagram illustrating an exemplary structure of a second magnet and a third magnet according to some embodiments of the present disclosure. FIG. 11B is a schematic diagram illustrating an exemplary structure of a second magnet and a third magnet according to some other embodiments of the present disclosure. In FIG. 11A, the ratio of the area of the cross-section of the second magnet 341 along the axis of the second magnet 341 to the area of the cross-section of the third magnet 343 along the axis of the third magnet 343 is 0.1. In FIG. 11B, the area ratio of the area of the cross-section of the second magnet 341 along the axis of the second magnet 341 to the area of the cross-section of the third magnet 343 along the axis of the third magnet 343 is 4. FIG. 11C is a graph illustrating effect of an area ratio of a second magnet to a third magnet on a magnetic flux intensity at a first coil according to some embodiments of the present disclosure. In FIG. 11C, a horizontal coordinate represents the area ratio of the second magnet 341 to the third magnet 343, and a vertical coordinate represents the magnetic flux intensity at the first coil. As may be seen from FIG. 11C, the magnetic flux intensity at the first coil increases as the area ratio of the second magnet 341 to the third magnet 343 increases. Based on this, in some embodiments, to increase the magnetic flux intensity at the first coil and thereby increasing a sound pressure level of a sound output by the first loudspeaker 330, the ratio of the area of the cross-section of the second magnet 341 along the axis of the second magnet 341 to the area of the third magnet 343 along the axis of the third magnet 343 may be in a range of 0.1 to 4.

In some embodiments, to ensure the performance of the second loudspeaker 340, the ratio of the area of the cross-section of the second magnet 341 perpendicular to the axis of the second magnet 341 to the area of the cross-section of the third magnet 343 perpendicular to the axis of the third magnet 343 is in a range of 0.4 to 0.6.

In some embodiments, a magnetic flux intensity at any position on the first coil of the first loudspeaker 330 is greater than 0.45 T, and a magnetic flux intensity at any position on the second coil of the second loudspeaker 340 is greater than 0.3 T, which enables both a sound output by the first loudspeaker 330 and a sound output by the second loudspeaker 340 to have a relatively large sound pressure level, thereby increasing the listening volume for the user. In some embodiments, to further increase the sound pressure levels of the sounds output by the first loudspeaker 330 and the second loudspeaker 340, the magnetic flux intensity at any position on the first coil of the first loudspeaker 330 is greater than 0.56 T, and the magnetic flux intensity at any position on the second coil of the second loudspeaker 340 is greater than 0.54 T.

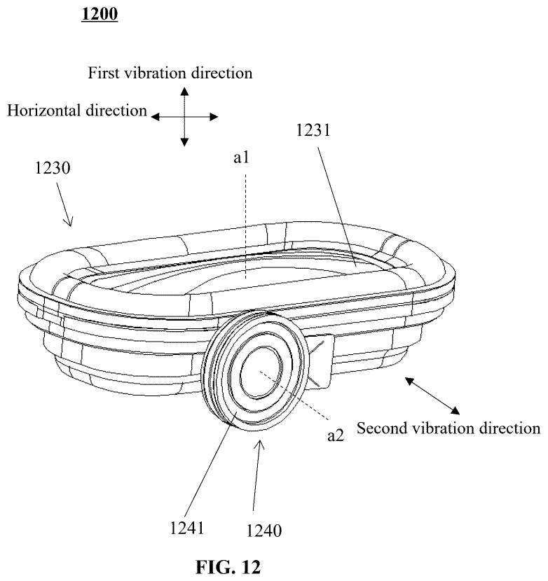

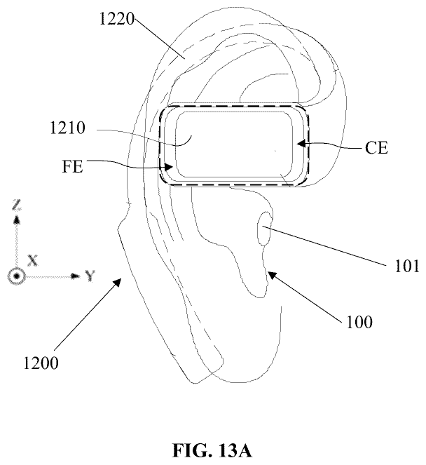

FIG. 12 is a schematic diagram illustrating another exemplary structure of an acoustic output device according to some embodiments of the present disclosure. As shown in FIG. 12, an acoustic output device 1200 includes a housing, a support structure, a first loudspeaker 1230, and a second loudspeaker 1240. The housing and the support structure of the acoustic output device 1200 are substantially the same as the housing 310 and the support structure 320 of the acoustic output device 300, respectively. The structure and the acoustic principle of the first loudspeaker 1230 and the second loudspeaker 1240 of the acoustic output device 1200 are substantially the same as the structure and the acoustic principle of the first loudspeaker 330 and the second loudspeaker 340 of the acoustic output device 300. For example, the first loudspeaker 1230 includes a first magnet 1231 and a first diaphragm. The first magnet 1231 and the first diaphragm are spaced apart along a vibration direction of the first diaphragm (e.g., a first vibration direction shown in FIG. 12). The second loudspeaker 1240 includes a second magnet 1241 and a second diaphragm. The second magnet 1241 and the second diaphragm are spaced apart along a vibration direction of the second diaphragm (e.g., a second vibration direction shown in FIG. 12). As another example, the first loudspeaker 1230 includes a first coil. The first coil is connected to the first diaphragm and is at least partially located in a magnetic field formed by the first magnet 1231, and the first coil drives the first diaphragm to vibrate to produce a sound after being energized. The second loudspeaker 1240 includes a second coil. The second coil is connected to the second diaphragm and is at least partially located in a magnetic field formed by the second magnet 1241, and the second coil drives the second diaphragm to vibrate to produce a sound after being energized. A difference is that, in the acoustic output device 1200, an axis of the second magnet 1241 is arranged inclined relative to an axis of the first magnet 1231.

The axis a1 of the first magnet 1231 is inclined relative to the axis a2 of the second magnet 1241. An angle greater than 0°is formed between the axis a1 of the first magnet 1231 and the axis a2 of the second magnet 1241. For example, the angle formed between the axis a1 of the first magnet 1231 and the axis a2 of the second magnet 1241 is 10°, 20°, 30°, 40°, 50°, 60°, 70°, 80°, or 90°. Referring to FIG. 12, in some embodiments, the second loudspeaker 1240 is arranged on a peripheral side surface of the first loudspeaker 1230. In this case, the angle formed between the axis a1 of the first magnet 1231 and the axis a2 of the second magnet 1241 is 90°. For example, a bottom of a magnetic circuit assembly of the second loudspeaker 1240 faces a side wall of a magnetic circuit assembly of the first loudspeaker 1230. Merely by way of example, the bottom of the magnetic circuit assembly of the second loudspeaker 1240 is a surface of the second magnet 1241 facing away from the second diaphragm. A side wall of the magnetic circuit assembly of the first loudspeaker 1230 may be a side wall of an accommodation member. As described above, since the vibration direction of the first diaphragm is parallel to the axis a1 of the first magnet 1231, and the vibration direction of the second diaphragm is parallel to the axis a2 of the second magnet 1241, when the axis a1 of the first magnet 1231 is inclined relative to the axis a2 of the second magnet 1241, the vibration direction of the first diaphragm is also inclined relative to the vibration direction of the second diaphragm. By arranging the axis of the second magnet 1241 inclined relative to the axis of the first magnet 1231, it is possible to facilitate arranging a second sound outlet hole of the second loudspeaker 340 closer to an opening of the ear canal (e.g., in a wearing manner shown in FIG. 13A), thereby increasing a listening volume of a high-frequency sound output by the second loudspeaker 340.

By arranging the axis of the second magnet 1241 inclined relative to the axis of the first magnet 1231, a coupling effect between the second magnet 1241 and the first magnet 1231 is weakened, leading to a magnetic field of the first coil of the first loudspeaker 1230 being less affected by the second magnet 1241 of the second loudspeaker 1240 overall.

In some embodiments, when the axis of the second magnet 1241 is arranged inclined relative to the axis of the first magnet 1231, on a plane where a surface of the first magnet 1231 facing the first diaphragm is located, there is a spacing between an orthogonal projection of the second diaphragm and an orthogonal projection of the first diaphragm. That is, along the direction perpendicular to the vibration direction of the first diaphragm (e.g., a horizontal direction shown in FIG. 12), the first diaphragm and the second diaphragm are spaced apart. In this case, the first magnet 1231 and the second magnet 1241 are also spaced apart. Since the second loudspeaker 1240 in FIG. 12 is only located on one side of the first loudspeaker 1230, which presents asymmetry, by arranging the first magnet 1231 and the second magnet 1241 in an inclined and spaced manner, the coupling between the second magnet 1241 and the first magnet 1231 may be further reduced, which makes a distribution of magnetic fields at various positions on the first coil of the first loudspeaker 1230 more uniform, thereby avoiding unstable vibration of the first coil caused by an unstable magnetic field.

In other embodiments, when the axis of the second magnet 1241 is arranged inclined relative to the axis of the first magnet 1231, the orthogonal projection of the second diaphragm and the orthogonal projection of the first diaphragm are at least partially overlapped, thereby ensuring a smaller dimension of the acoustic output device 1200. In cases where there is a higher requirement for the dimension of the acoustic output device 1200, a relative position between the first diaphragm (the first magnet 1231) and the second diaphragm (the second magnet 1241) may be set according to the manner in the present embodiment.

In some embodiments, a frequency of at least a portion of sounds output by the first loudspeaker 1230 is lower than a frequency of sounds output by the second loudspeaker 1240. Similar to the types of the first loudspeaker 330 and the second loudspeaker 340 of the acoustic output device 300, the first loudspeaker 1230 of the acoustic output device 1200 is a low-frequency loudspeaker or a mid-low-frequency loudspeaker, and the second loudspeaker 1240 is a high-frequency loudspeaker. In some embodiments, a frequency range of a first sound output by the first loudspeaker 1230 and a frequency range of a second sound output by the second loudspeaker 1240 are not overlapped. For example, a minimum frequency in the frequency range of the second sound is higher than a maximum frequency in the frequency range of the first sound. In some embodiments, the frequency range of the first sound output by the first loudspeaker 1230 and the frequency range of the second sound output by the second loudspeaker 1240 are overlapped. For example, a minimum frequency in the frequency range of the second sound is lower than a maximum frequency in the frequency range of the first sound, and a maximum frequency in the frequency range of the second sound is higher than the maximum frequency in the frequency range of the first sound. For more content regarding the low-frequency loudspeaker and the high-frequency loudspeaker, reference may be made to the relevant descriptions above, which will not be repeated herein.

In some embodiments, the housing of the acoustic output device 1200 has other wearing manners different from the manner the housing 310 of the acoustic output device 300 extends into the concha cavity. FIG. 13A is a schematic diagram illustrating another wearing manner of an acoustic output device according to some embodiments of the present disclosure. Referring to FIG. 13A, in a wearing state, a support structure 1220 of the acoustic output device 1200 may position a housing 1210 at an antihelix of an ear, and a portion of a side surface of the housing 1210 abuts against the antihelix. By positioning at least a portion of the housing 1210 at the antihelix of a user, the output effect of the acoustic output device 1200 may be improved, i.e., increasing a sound intensity at a near-field listening position while reducing a volume of far-field sound leakage. When the user wears the acoustic output device 1200, one or more sound outlet holes may be disposed on a side wall of the housing 1210 close to or facing an ear canal of the user, and one or more pressure relief holes may be disposed on other side walls of the housing 1210 (e.g., a side wall away from or facing away from the ear canal of the user). For example, when one sound outlet hole is disposed on the housing 1210, the first loudspeaker 1230 and the second loudspeaker 1240 share the sound outlet hole. As another example, when two sound outlet holes are disposed on the housing 1210, one sound outlet hole is configured to output a high-frequency sound, and the other sound outlet hole is configured to output a low-frequency sound or a mid-low-frequency sound. As a further example, when more than two sound outlet holes are disposed on the housing 1210, a portion of the sound outlet holes is configured to output a high-frequency sound, and another portion of the sound outlet holes is configured to output a low-frequency sound or a mid-low-frequency sound. Taking the housing 1210 including one sound outlet hole and one pressure relief hole as an example, the sound outlet hole is acoustically coupled to a front cavity of the acoustic output device 1200, and the pressure relief hole is acoustically coupled to a rear cavity of the acoustic output device 1200. A sound output by the sound outlet hole and a sound output by the pressure relief hole may be approximately regarded as two sound sources, with the two sound sources having equal sound magnitudes and opposite phases. The sound emitted from the sound outlet hole may be directly transmitted to an opening of the ear canal of the user without obstruction, while the sound emitted from the pressure relief hole needs to bypass the housing 1210 or pass through the housing 1210 to form an acoustic model similar to that shown in FIG. 13B. As shown in FIG. 13B, when a baffle is disposed between a point sound source A₁ and a point sound source A₂, in a near field, a sound field of the point sound source A₂ needs to bypass the baffle to interfere with a sound wave of the point sound source A₁ at a listening position, which is equivalent to increasing an acoustic path from the point sound source A₂ to the listening position. Therefore, assuming the point sound source A₁ and the point sound source A₂ have the same amplitude, compared to a case without the baffle, an amplitude difference between the sound wave of the point sound source A₁ and a sound wave of the point sound source A₂ at the listening position increases, which reduces a cancellation degree between two sounds at the listening position, thereby increasing a volume at the listening position. In a far field, since the sound waves generated by the point sound source A₁ and the point sound source A₂ may interfere over a large spatial range without needing to bypass the baffle (similar to the case without the baffle), compared to the case without the baffle, far-field sound leakage does not increase significantly. Therefore, disposing a baffle structure around one of the point sound source A₁ or the point sound source A₂ may significantly increase a volume at a near-field listening position without significantly increasing a volume of far-field sound leakage.

Furthermore, since the housing 1210 does not block the opening of the ear canal in the manner shown in FIG. 13A and the listening volume is high, in this wearing manner, the overall dimension of the acoustic output device 1200 may be reduced by reducing the dimension between the two loudspeakers, which allows the acoustic output device 1200 to have a high listening effect while also improving wearing comfort. This is because, compared to a manner in which the two loudspeakers in the acoustic output device 300 are stacked, the arrangement manner of the two loudspeakers in the acoustic output device 1200 may reduce the dimension of the acoustic output device 1200 along the vibration direction of the first diaphragm (also referred to as a thickness dimension of the acoustic output device 1200). Combined with the wearing manner shown in FIG. 13A, a reduced thickness dimension of the acoustic output device 1200 may make the mass of the center of the acoustic output device 1200 more biased towards the antihelix, preventing the acoustic output device 1200 from deflecting due to gravity, thereby enhancing the wearing stability and ensuring a listening effect.

In the wearing manner shown in FIG. 13A, the housing 1210 of the acoustic output device 1200 is located at the antihelix. In this case, an inner side surface of the housing 1210 faces the ear of the user, and a lower side surface of the housing 1210 is a side surface of the housing 1210 facing away from a top of the head of the user. Compared to other side surfaces of the housing 1210, the lower side surface of the housing 1210 is closer to the opening of the ear canal.

In some embodiments, a first sound outlet hole and a second sound outlet hole are disposed on the lower side surface of the housing 1210 of the acoustic output device 1200. The first sound outlet hole is acoustically coupled to the first diaphragm, and a sound produced by the first diaphragm radiates outward through the first sound outlet hole. The second sound outlet hole is acoustically coupled to the second diaphragm, and a sound produced by the second diaphragm radiates outward through the second sound outlet hole. In the wearing manner where the housing 1210 of the acoustic output device 1200 abuts against the antihelix, when both the first sound outlet hole and the second sound outlet hole are located on the lower side surface of the housing 1210, the first sound outlet hole and the second sound outlet hole may be closer to the opening of the ear canal, which particularly reduces a propagation distance of a sound output by the second loudspeaker, thereby improving the listening effect of the acoustic output device 1200.

In some embodiments, in the wearing state, the second sound outlet hole is closer to the opening of the ear canal than the first sound outlet hole, i.e., a sound outlet hole corresponding to the high-frequency loudspeaker is closer to the opening of the ear canal. Merely by way of example, in the wearing state, an orthogonal projection of a centroid of the second sound outlet hole on the sagittal plane is closer to the opening of the ear canal than an orthogonal projection of a centroid of the first sound outlet hole on the sagittal plane. Given that a high-frequency sound output by the second loudspeaker 1240 has strong directivity, by arranging the second sound outlet hole closer to the opening of the ear canal, a listening volume of the high-frequency sound output by the second loudspeaker 1240 may be further increased, thereby improving the sound effect of the acoustic output device 1200.

In some embodiments, the first sound outlet hole and the second sound outlet hole are disposed on different side surfaces of the housing 1210. In some embodiments, the first sound outlet hole is disposed on the inner side surface of the housing 1210, and the second sound outlet hole is disposed on the lower side surface of the housing 1210. In the wearing state shown in FIG. 13A, disposing the second sound outlet hole of the second loudspeaker 1240 on the lower side surface of the housing 1210 may make the second sound outlet hole closer to the opening of the ear canal, thereby making the sound output by the second loudspeaker 1240 have stronger directivity, thus further improving the sound effect of the acoustic output device 1200. In some embodiments, a pressure relief hole may be disposed on the housing 1210, and the pressure relief hole is acoustically coupled to the first diaphragm. In some embodiments, the pressure relief hole is located on the lower side surface or an upper side surface of the housing 1210. In other embodiments, the pressure relief hole is also disposed on other side surfaces of the housing 1210, which is not limited herein.

In some embodiments, the second sound outlet hole is disposed on a connection surface of the housing. The connection surface refers to a surface on the housing that connects the lower side surface and the inner side surface. In the wearing state as shown in FIG. 13A, since the lower side surface of the housing 1210 faces away from the top of the head, and the inner side surface of the housing 1210 faces the antihelix, by disposing the connection surface between the lower side surface and the inner side surface, the second sound outlet hole can better point toward the opening of the ear canal, which enables a stronger directivity for the sound output by the second loudspeaker 1240, thereby further improving the sound effect of the acoustic output device 1200.

In some embodiments, an axis of the first magnet 1231 is perpendicular to an axis of the second magnet 1241. That is, the angle between the axis a1 of the first magnet 1231 and the axis a2 of the second magnet 1241 in FIG. 12 is 90°. At this time, a vibration direction of the first diaphragm is perpendicular to a vibration direction of the second diaphragm. The first magnet 1231 and the second magnet 1241 are spaced apart along the vibration direction of the second diaphragm. In other embodiments, the second magnet 1241 and the first magnet 1231 are spaced apart along other directions. There is a certain angle between the other directions and the axis of the first magnet 1231 (or the axis of the second magnet 1241), e.g., 10°, 20°, 30°, 40°, 50°, or 60°. In other embodiments, the angle between the axis a2 of the second magnet 1241 and the axis a1 of the first magnet 1231 is in a range of 10°to 45°.

In some embodiments, when the axis a1 of the first magnet 1231 and the axis a2 of the second magnet 1241 are arranged at an angle, the N pole of the first magnet 1231 faces the first diaphragm and the N pole of the second magnet 1241 faces the first magnet 1231. In some embodiments, the S pole of the first magnet 1231 faces the first diaphragm, and the S pole of the second magnet 1241 faces the first magnet 1231. In some embodiments, a third magnet arrangement manner is that the N pole of the first magnet 1231 faces the first diaphragm, and the S pole of the second magnet 1241 faces the first magnet 1231. In some embodiments, a fourth magnet arrangement manner is that the S pole of the first magnet 1231 faces the first diaphragm, and the N pole of the second magnet 1241 faces the first magnet 1231.

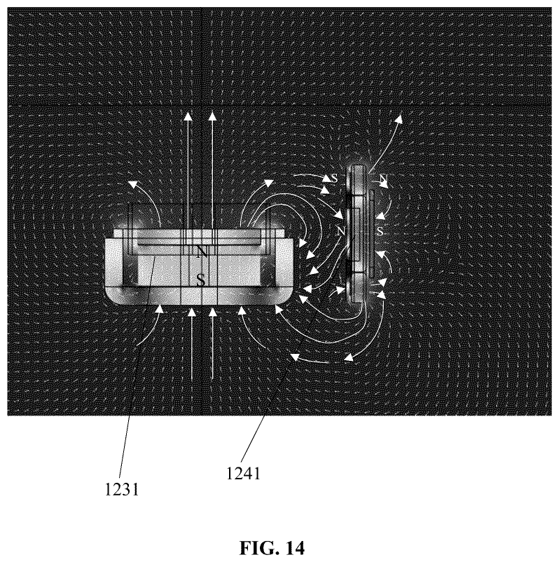

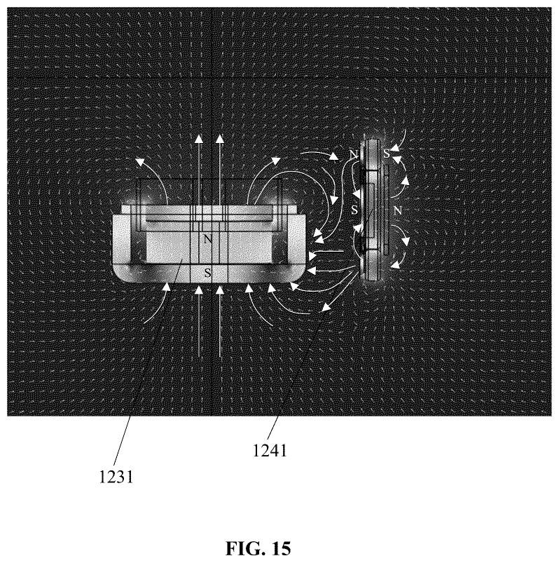

FIG. 14 is a schematic diagram illustrating a distribution of magnetic fields of a first loudspeaker and a second loudspeaker arranged in a first magnet arrangement manner according to some embodiments of the present disclosure. At this time, the N pole of the first magnet 1231 faces the first diaphragm, and the N pole of the second magnet 1241 faces the first magnet 1231. FIG. 15 is a schematic diagram illustrating a distribution of magnetic fields of a first loudspeaker and a second loudspeaker arranged in a third magnet arrangement manner according to other embodiments of the present disclosure. At this time, the N pole of the first magnet 1231 faces the first diaphragm, and the S pole of the second magnet 1241 faces the first magnet 1231. With reference to FIG. 14 and FIG. 15, after a magnetic field generated by the second loudspeaker 1240 is coupled with a magnetic field generated by the first loudspeaker 1230, and according to a distribution of magnetic flux lines of the two magnets, if the N pole of the first magnet 1231 faces the first diaphragm, compared to the S pole of the second magnet facing the first magnet 1231 (as shown in FIG. 15), when the N pole of the second magnet faces the first magnet 1231 (as shown in FIG. 14), the magnetic flux intensity at the second coil of the second loudspeaker 1240 is generally increased.

In some embodiments, there is a third distance between a magnetic circuit where the first magnet 1231 is located and a magnetic circuit where the second magnet 1241 is located. The third distance refers to a shortest distance between the magnetic circuit where the first magnet 1231 is located and the magnetic circuit where the second magnet 1241 is located. Merely by way of example, when the axis of the first magnet 1231 is perpendicular to the axis of the second magnet 1241, the third distance is a shortest distance, along the vibration direction of a second diaphragm, between a bottom of the magnetic circuit of the second loudspeaker 1240 (e.g., a surface of a magnetic conductive member/accommodation member facing away from the second diaphragm) and a side wall of an accommodation member of a magnetic circuit assembly of the first loudspeaker 1230.

In some embodiments, to ensure that the first loudspeaker 1230 does not affect the vibration of the second diaphragm, the third distance is greater than 1.5 mm. In some embodiments, to ensure that the dimension of the acoustic output device 1200 is not too large, the third distance is less than 2.5 mm. In some embodiments, the third distance affects a coupling situation between the first magnetic field generated by the first loudspeaker 1230 and the second magnetic field generated by the second loudspeaker 1240. In some embodiments, the third distance is in a range of 1.7 mm to 2.3 mm. In some embodiments, the third distance is in a range of 1.9 mm to 2.1 mm.

In some embodiments, an inner cavity formed by the housing 1210 includes a first cavity and a second cavity that are separated from each other. The first loudspeaker 1230 is accommodated within the first cavity, and the second loudspeaker 1240 is accommodated within the second cavity. In some embodiments, a partition plate is disposed in the housing 1210. The partition plate separates the inner cavity formed by the housing 1210 into the first cavity accommodating the first loudspeaker 330 and the second cavity accommodating the second loudspeaker 340. At this time, the first diaphragm of the first loudspeaker 1230 separates the first cavity into a first front cavity and a first rear cavity. The first front cavity is acoustically coupled to a first sound outlet hole, and a sound generated in the first front cavity of the first loudspeaker 1230 is radiated outward through the first sound outlet hole. The second diaphragm of the second loudspeaker 1240 separates the second cavity into a second front cavity and a second rear cavity. The second front cavity is acoustically coupled to a second sound outlet hole, and a sound generated in the second front cavity of the second loudspeaker 1240 is radiated outward through the second sound outlet hole. The first front cavity of the first loudspeaker 1230 and the second front cavity of the second loudspeaker 1240 are not in acoustic communication with each other (i.e., the first loudspeaker 1230 and the second loudspeaker 1240 do not share the same sound outlet hole). Such the arrangement may prevent the sounds radiated by the first loudspeaker 1230 and the second loudspeaker 1240 from interfering with each other, thereby reducing the mutual radiation impedance.

Similar to the arrangement where the second loudspeaker 340 of the acoustic output device 300 includes the third magnet 343, the second loudspeaker 1240 of the acoustic output device 1200 further includes a third magnet (not shown in the figure). The third magnet is arranged surrounding the second magnet 1241. For example, the third magnet may be an annular magnet arranged surrounding the second magnet 1241.

In some embodiments, identical magnetic poles of the third magnet and the second magnet 1241 are oriented in opposite directions. In this arrangement, on the one hand, a magnetic field generated by the third magnet may increase the magnetic field strength at the second coil of the second loudspeaker 1240. On the other hand, the third magnet may increase a magnetic field strength of the second magnet 1241 at the second coil.

Similar to the arrangement where the second loudspeaker 340 of the acoustic output device 300 includes the fourth magnet 344, the second loudspeaker 1240 of the acoustic output device 1200 further includes a fourth magnet (not shown in the figure). The fourth magnet and the second magnet 1241 are arranged along the vibration direction of the second diaphragm, and identical magnetic poles of the fourth magnet and the second magnet 1241 are disposed opposite each other. In this arrangement, more magnetic flux lines may vertically pass through the second coil, increasing the magnetic flux intensity at the second coil and suppressing magnetic leakage, thereby increasing the sensitivity of the second loudspeaker 1240.

In some embodiments, when the third magnet is arranged surrounding the second magnet 1241, a magnetic field generated by the second magnet 1241 may enhance a magnetic flux intensity at the first coil of the first loudspeaker 1230, while the magnetic field generated by the third magnet reduces the magnetic flux intensity at the first coil. Since the effects of the second magnet 1241 and the third magnet on the magnetic flux intensity at the first coil are opposite, it is necessary to set dimensions of the second magnet 1241 and the third magnet to ensure that a combined magnetic field of the second loudspeaker 1240 (i.e., a combined magnetic field obtained after coupling the magnetic field generated by the second magnet 1241 and the magnetic field generated by the third magnet) may enhance the magnetic flux intensity at the first coil. In this embodiment, a dimension of a magnet is characterized by an area of a cross-section of the magnet perpendicular to an axis of the magnet. In some embodiments, to increase the magnetic flux intensity at the first coil to improve a sound pressure level of a sound output by the first loudspeaker 1230, a ratio of an area of a cross-section of the second magnet 1241 along an axis of the second magnet 1241 to an area of a cross-section of the third magnet along an axis of the third magnet is in a range of 0.1 to 4.

In some embodiments, to ensure the performance of the second loudspeaker 1240, the ratio of the area of the cross-section of the second magnet 1241 perpendicular to the axis of the second magnet 1241 to the area of the cross-section of the third magnet perpendicular to the axis of the third magnet is in a range of 0.4 to 0.6. For more content regarding the third magnet and the fourth magnet of the second loudspeaker 1240, reference may be made to the related descriptions above, e.g., FIG. 8 to FIG. 10 and the related descriptions thereof.

In some embodiments, a magnetic flux intensity at any position on the first coil of the first loudspeaker 1230 is in a range of 0.44 T to 0.67 T, and a magnetic flux intensity at any position on the second coil of the second loudspeaker 1240 is in a range of 0.3 T to 0.6 T. Such the arrangement may allow both the sounds output by the first loudspeaker 330 and the second loudspeaker 340 to have a relatively large sound pressure level, thereby increasing a listening volume for a user. In some embodiments, to further increase the sound pressure level of the sounds output by the first loudspeaker 1230 and the second loudspeaker 1240, the magnetic flux intensity at any position on the first coil of the first loudspeaker 1230 is in a range of 0.549 T to 0.562 T, and the magnetic flux intensity value at any position on the second coil of the second loudspeaker 1240 is in a range of 0.453 T to 0.472 T.

The basic concepts have been described above. Obviously, for those skilled in the art, the above detailed disclosure is merely an example and does not constitute a limitation to the present disclosure. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of the present disclosure.

Moreover, certain terminology has been configured to describe embodiments of the present disclosure. Such as “one embodiment,” “an embodiment,” and/or “some embodiments” mean a certain feature, structure, or characteristic related to at least one embodiment of the present disclosure. Therefore, it should be emphasized and noted that “an embodiment” or “one embodiment” or “an alternative embodiment” mentioned two or more times in different locations in the present disclosure does not necessarily refer to the same embodiment. In addition, some features, structures, or features in the present disclosure of one or more embodiments may be appropriately combined.

In addition, those skilled in the art can understand that aspects of the present disclosure may be illustrated and described by several patentable categories or situations, including any new and useful process, machine, product, or combination of substances, or any new and useful improvement thereof. Accordingly, all aspects of the present disclosure may be performed entirely by hardware, may be performed entirely by software (including firmware, resident software, microcode, etc.), or may be performed by a combination of hardware and software. The above hardware or software can be referred to as “data block”, “module”, “engine”, “unit”, “component”, or “system”. In addition, aspects of the present disclosure may appear as a computer product located in one or more computer-readable media, the product including computer-readable program code.

A computer storage medium may include a propagated data signal containing computer program code, for example, on a baseband or as part of a carrier wave. The propagated data signal may have various manifestations, including electromagnetic, optical, etc., or a suitable combination thereof. The computer storage medium may be any computer-readable medium other than a computer-readable storage medium, which may be connected to an instruction execution system, apparatus, or device to achieve communication, propagation, or transmission of a program for use. Program codes located on the computer storage medium may be propagated via any suitable medium, including radio, cable, fiber optic cable, RF, or similar medium, or any combination of the above media.

Computer program codes required for the operation of various parts of the present disclosure may be written in any one or more programming languages, including object-oriented programming languages such as Java, Scala, Smalltalk, Eiffel, JADE, Emerald, C++, C#, VB.NET, Python, etc., conventional procedural programming languages such as C language, Visual Basic, Fortran 2003, Perl, COBOL 2002, PHP, ABAP, dynamic programming languages such as Python, Ruby, and Groovy, or other programming languages. The computer program codes may run entirely on a user's computer, run as a standalone software package on the user's computer, run partly on the user's computer and partly on a remote computer, or run entirely on the remote computer or processing device. In the latter case, the remote computer may be connected to the user's computer through any type of network, such as a local area network (LAN) or a wide area network (WAN), or connected to an external computer (e.g., via the Internet), or in a cloud computing environment, or used as a service such as software as a service (SaaS).

In addition, unless explicitly stated in the claims, the order of processing elements and sequences, the use of numbers and letters, or the use of other names in the present disclosure are not intended to limit the order of processes and methods of the present disclosure. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the system components described above may be implemented by hardware devices, they may also be implemented solely by software solutions, such as installing the described system on existing processing devices or mobile devices.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, numbers describing quantities of components or attributes are used. It should be understood that such numbers used in the description of embodiments are modified by the modifiers “about”, “approximately”, or “substantially” in some examples. Unless otherwise stated, “about”, “approximately”, or “substantially” indicates that the stated number allows a variation of ±20%. Accordingly, in some embodiments, the numerical parameters used in the present disclosure and claims are approximations, which may vary depending on the desired characteristics of individual embodiments. In some embodiments, numerical parameters should consider the specified number of significant digits and adopt the method of general digit retention. Although the numerical ranges and parameters configured to confirm the breadth of their scope in some embodiments of the present disclosure are approximations, in specific embodiments, the setting of such numerical values is as precise as possible within the feasible range.

For each patent, patent application, patent application publication, and other material, such as articles, books, specifications, publications, documents, etc., cited in the present disclosure, the entire contents thereof are hereby incorporated by reference into the present disclosure. This excludes application history documents that are inconsistent with or conflict with the content of the present disclosure, and also excludes documents that limit the broadest scope of the claims of the present disclosure (currently or subsequently appended to the present disclosure). It should be noted that if the description, definition, and/or use of terms in the ancillary materials of the present disclosure are inconsistent with or conflict with the content described in the present disclosure, the description, definition, and/or use of terms in the present disclosure shall prevail.

At last, it should be understood that the embodiments described in the present disclosure are merely illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

1. An acoustic output device, comprising:
a housing, the housing forming an inner cavity;
a support structure, the support structure being configured to position the housing on an ear while not blocking an ear canal;
a first loudspeaker, the first loudspeaker being accommodated within the inner cavity; the first loudspeaker including a first magnet and a first diaphragm, the first magnet and the first diaphragm being spaced apart along a vibration direction of the first diaphragm; and
a second loudspeaker, the second loudspeaker being accommodated within the inner cavity; the second loudspeaker including a second magnet and a second diaphragm, the second magnet and the second diaphragm being spaced apart along a vibration direction of the second diaphragm, wherein
the first magnet and the second magnet are spaced apart along the vibration direction of the first diaphragm; and identical magnetic poles of the first magnet and the second magnet are disposed opposite each other.

2. The acoustic output device of claim 1, wherein a frequency of at least a portion of sound output by the first loudspeaker is lower than a frequency of sound output by the second loudspeaker.

3. The acoustic output device of claim 1, wherein an axis of the first magnet is disposed parallel to and spaced apart from an axis of the second magnet.

4. The acoustic output device of claim 1, wherein a first sound outlet hole and a second sound outlet hole are disposed on an inner side surface of the housing, the first sound outlet hole is acoustically coupled to the first diaphragm, the second sound outlet hole is acoustically coupled to the second diaphragm, and the inner side surface is a side surface of the housing facing an opening of the ear canal in a wearing state.

5. The acoustic output device of claim 4, wherein in the wearing state, an orthogonal projection of a centroid of the second sound outlet hole on a sagittal plane of a human body is closer to the opening of the ear canal than an orthogonal projection of a centroid of the first sound outlet hole on the sagittal plane of the human body.

6. The acoustic output device of claim 4, wherein in the wearing state, an orthogonal projection of a center of the second magnet on a sagittal plane of a human body is closer to the opening of the ear canal than an orthogonal projection of a center of the first magnet on the sagittal plane of the human body.

7. The acoustic output device of claim 3, wherein on a plane where a surface of first magnet facing the first diaphragm is located, an orthogonal projection of the second magnet and an orthogonal projection of the first magnet are at least partially overlapped.

8. The acoustic output device of claim 3, wherein in the wearing state, at least a portion of the housing extends into a concha cavity of the ear, and at least a portion of a side surface of the housing abuts against the concha cavity.

9. The acoustic output device of claim 3, wherein the first diaphragm includes a main body region and a folded annular region surrounding the main body region, the main body region includes a dome-shaped portion, a projection of a center of the second magnet on the first diaphragm along an axis of the second magnet is located between a center of the dome-shaped portion and an inner edge of the folded annular region, and the inner edge of the folded annular region is connected to the dome-shaped portion.

10. The acoustic output device of claim 1, wherein the inner cavity includes a first cavity and a second cavity separated from each other, the first loudspeaker is accommodated within the first cavity, and the second loudspeaker is accommodated within the second cavity.

11. The acoustic output device of claim 3, wherein a first distance between a magnetic circuit where the first magnet is located and a magnetic circuit where the second magnet is located along the vibration direction of the first diaphragm is in a range of 2.85 mm to 3.42 mm.

12. (canceled)

13. The acoustic output device of claim 3, wherein on a plane of where a surface of the first magnet facing the first diaphragm is located, a distance between an orthogonal projection of a centroid of the first diaphragm and an orthogonal projection of a centroid of the second diaphragm is in a range of 0 mm to 8 mm.

14. The acoustic output device of claim 1, wherein the second loudspeaker further includes a third magnet, and the third magnet is arranged surrounding the second magnet.

15. The acoustic output device of claim 14, wherein the second loudspeaker further includes a fourth magnet, the fourth magnet and the second magnet are arranged along the vibration direction of the second diaphragm, and identical magnetic poles of the fourth magnet and the second magnet are disposed opposite each other.

16. The acoustic output device of claim 14, wherein a ratio of an area of a cross-section of the second magnet perpendicular to an axis of the second magnet to an area of a cross-section of the third magnet perpendicular to an axis of the third magnet is in a range of 0.1 to 4.

17. (canceled)

18. The acoustic output device of claim 1, wherein
the first loudspeaker includes a first coil, the first coil is connected to the first diaphragm and at least partially located in a magnetic field formed by the first magnet, and the first coil drives the first diaphragm to vibrate to produce sound after being energized; and a magnetic flux intensity at any position on the first coil is greater than 0.45 T; and/or,
the second loudspeaker includes a second coil, the second coil is connected to the second diaphragm and at least partially located in a magnetic field formed by the second magnet, and the second coil drives the second diaphragm to vibrate to produce sound after being energized; and a magnetic flux intensity at any position on the second coil is greater than 0.3 T.

19. An acoustic output device, comprising:
a housing, the housing forming an inner cavity;
a support structure, the support structure being configured to position the housing on an ear while not blocking an ear canal.
a first loudspeaker, the first loudspeaker being accommodated within the inner cavity; the first loudspeaker including a first magnet and a first diaphragm, the first magnet and the first diaphragm being spaced apart along a vibration direction of the first diaphragm; and
a second loudspeaker, the second loudspeaker being accommodated within the inner cavity; the second loudspeaker including a second magnet and a second diaphragm, the second magnet and the second diaphragm being spaced apart along a vibration direction of the second diaphragm, wherein
an axis of the second magnet is inclined relative to an axis of the first magnet.

20. The acoustic output device of claim 19, wherein on a plane where a surface of the first magnet facing the first diaphragm is located, there is a spacing between an orthogonal projection of the second diaphragm and an orthogonal projection of the first diaphragm.

21. The acoustic output device of claim 19, wherein a frequency of at least a portion of sound output by the first loudspeaker is lower than a frequency of sound output by the second loudspeaker.

22. The acoustic output device of claim 19, wherein a first sound outlet hole and a second sound outlet hole are disposed on a lower side surface of the housing, the first sound outlet hole is acoustically coupled to the first diaphragm, and the second sound outlet hole is acoustically coupled to the second diaphragm; and the lower side surface is a side surface of the housing facing away from a top of the head of a user in a wearing state.

23-33. (canceled)
